(19) United States
(12) Patent Application Publication
(10) Pub. No.: US 2025/0225496 A1
(43) Pub. Date: Jul. 10, 2025

(54) FRICTIONLESS STORE

(71) Applicant: Toshiba Global Commerce Solutions, Inc., Durham, NC (US)

(72) Inventor: Evgeny Shevstov, Plano, TX (US)

(73) Assignee: Toshiba Global Commerce Solutions, Inc., Durham, NC (US)

(21) Appl. No.: 19/011,269

(22) Filed: Jan. 6, 2025

Related U.S. Application Data
(63) Continuation of application No. 63/617,907, filed on Jan. 5, 2024.

(51) Int. Cl. G06Q 20/14; G06F 3/14; G06Q 20/20; G06Q 20/32; G06T 7/70; G06V 20/52

(52) U.S. Cl. CPC G06Q 20/145; G06F 3/1423; G06Q 20/203; G06Q 20/321; G06T 7/70; G06V 20/52; G06T 2207/30196; G06T 2207/30232

(57) ABSTRACT

Systems and methods of conducting frictionless shopping are provided. In one exemplary embodiment, a method is performed by a network node device operationally coupled over a network to optical sensor devices positioned throughout a retail space having shelf structures. Each shelf structure has display devices with each display device being associated with and proximate a certain stocked item of the set of stocked items that is disposed on that shelf structure. The method includes sending, to a first display device that is associated with and proximate a certain stocked item that is electronically requested, over the network, an indication that includes a request to enable an auditory or visual indication so that the certain stocked item can be located on the corresponding shelf structure of the set of shelf structures in the retail space based on the auditory or visual indication.

### CROSS REFERENCE TO RELATED APPLICATIONS

The present application claims the benefit of U.S. Provisional App. No. 63/617,907, filed Jan. 5, 2024, which is hereby incorporated by reference in its entirety.

### BACKGROUND

In a frictionless store, a shopper can check in and enter a store electronically, browse for retail items, place retail items in bags, containers or carts, and exit the store without any interaction with a store clerk or self-checkout station. The retail items that the shopper possesses when leaving the retail store are recognized through image processing and an account associated with the shopper is automatically charged for the price of each retail item possessed. As such, a frictionless store allows for a quick and easy shopping experience and is commonly referred to as frictionless shopping since the shopper does not have to interact with any store clerk or self-checkout station to purchase items.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIGS. 1A-B illustrate one embodiment of a frictionless system operable to enable frictionless shopping in a frictionless store in accordance with various aspects as described herein.

FIG. 2 illustrates one embodiment of a network node device in accordance with various aspects as described herein.

FIG. 3A illustrates another embodiment of a network node device in accordance with various aspects as described herein. FIG. 3B illustrates one embodiment of an optical sensor device in accordance with various aspects as described herein.

FIG. 4 illustrates one embodiment of a method performed by a network node device of performing frictionless shopping in a frictionless store in accordance with various aspects as described herein.

FIG. 5 illustrates another embodiment of a device in accordance with various aspects as described herein.

FIGS. 6A-6E illustrate embodiments of a frictionless store in accordance with various aspects as described herein.

FIGS. 7A-7I illustrate other embodiments of a frictionless store in accordance with various aspects as described herein.

FIG. 8 illustrates another embodiment of a frictionless system operable to enable frictionless shopping in a frictionless store in accordance with various aspects as described herein.

FIG. 9A is a perspective view of another embodiment of a frictionless store in accordance with various aspects as described herein. FIG. 9B is a plan view of the frictionless store of FIG. 9A. FIG. 9C is a perspective view of another embodiment of a frictionless store in accordance with various aspects as described herein. FIGS. 9D-9E are plan views of other embodiments of a frictionless store in accordance with various aspects as described herein.

FIG. 10A is a perspective view of one embodiment of a frictionless store in accordance with various aspects as described herein. FIG. 10B is a plan view of the frictionless store of FIG. 10A. FIG. 10C is a perspective view of another embodiment of a frictionless store in accordance with various aspects as described herein.

FIG. 11 illustrates another embodiment of a method of performing frictionless shopping in a frictionless store in accordance with various aspects as described herein.

FIGS. 12A-12C illustrate other embodiments of a method of performing frictionless shopping in a frictionless store in accordance with various aspects as described herein.

FIG. 13 illustrates one embodiment of a method of performing frictionless shopping in a frictionless store in accordance with various aspects as described herein.

FIGS. 14A-14C illustrate embodiments of a method of performing frictionless shopping in a frictionless store in accordance with various aspects as described herein.

FIG. 15A-1 illustrates another embodiment of a method of performing frictionless shopping in a frictionless store in accordance with various aspects as described herein. FIG. 15A-2 illustrates an example of retail items disposed on a shelf structure in accordance with various aspects described herein. FIG. 15A-3 is a plan view of the frictionless store of FIG. 15A-1. FIG. 15B-1 illustrates another embodiment of a method of performing frictionless shopping in a frictionless store in accordance with various aspects as described herein. FIG. 15B-2 to FIG. 15B-5 illustrate other examples of retail items disposed on a shelf structure in accordance with various aspects as described herein.

FIG. 16A illustrates another embodiment of a method of performing frictionless shopping in a frictionless store in accordance with various aspects as described herein. FIGS. 16B-16C illustrate other examples of retail items disposed on a shelf structure in accordance with various aspects as described herein. FIG. 16D is a plan view of the frictionless store of FIG. 16A.

FIG. 17 illustrates another embodiment of a method of performing frictionless shopping in a frictionless store in accordance with various aspects as described herein.

FIG. 18 illustrates another embodiment of a method of performing frictionless shopping in a frictionless store in accordance with various aspects as described herein.

FIGS. 19A-19B illustrate other embodiments of a method of performing frictionless shopping in a frictionless store in accordance with various aspects as described herein.

FIG. 20 illustrates another embodiment of a method of performing frictionless shopping in a frictionless store in accordance with various aspects as described herein.

FIG. 21 illustrates another embodiment of a frictionless store in accordance with various aspects as described herein.

FIGS. 22A-1 to 22A-4 illustrate one embodiment of components of a frictionless system operable to enable frictionless shopping in a frictionless store in accordance with various aspects as described herein. FIGS. 22B-22C illustrate other embodiments of a frictionless store in accordance with various aspects as described herein.

FIG. 23 illustrates another embodiment of a method of performing frictionless shopping in a frictionless store in accordance with various aspects as described herein.

FIG. 24 illustrates an exemplary virtual representation of a frictionless store in accordance with various aspects as described herein.

FIGS. 25A-25B illustrate plan views of other embodiments of a frictionless store in accordance with various aspects as described herein.

FIG. 26A illustrates another embodiment of a frictionless store in accordance with various aspects as described herein. FIG. 26B illustrates another exemplary component diagram of a frictionless system operable to enable frictionless shopping in the frictionless store of FIG. 26A.

FIG. 27A illustrates another embodiment of a frictionless store in accordance with various aspects as described herein. FIG. 27B illustrates another exemplary component diagram of a frictionless system operable to enable frictionless shopping in the frictionless store of FIG. 27A.

FIG. 28A illustrates another embodiments of a frictionless store in accordance with various aspects as described herein. FIG. 28B illustrates another exemplary component diagram of a frictionless system operable to enable frictionless shopping in the frictionless store of FIG. 28A.

FIG. 29 illustrates one embodiment of a communication layer of a frictionless system of a frictionless store in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

Electronic shelf label (ESL) display devices can be positioned on retail shelves such as on a front edge of a shelf and can be configured by retailors to display the price of stocked items, which can be automatically updated or changed under the control of a server. ESL display devices can include, for instance, electronic paper (E-paper) or liquid-crystal display (LCD) technology to display the current prices of the corresponding stocked items to the consumer. E-paper technology is widely used on ESL display devices as E-paper technology provides a clearly visible display and supports full graphic images while consuming power predominantly during display updates, with little to no power needed to retain the displayed image.

Furthermore, ESL display devices can reduce carbon footprint waste in retail stores by no longer requiring the replacement of paper shelf labels due to price or inventory changes and can enable real-time product price updates instead of requiring store clerks to manually replace paper shelf labels. A server can be configured to automatically update the displayed price on an ESL display device whenever the price of the corresponding stocked item is changed—in contrast to static placards (e.g., paper shelf labels) that require a manual process to prepare and install. When stocking shelves, store clerks can follow a planogram. In one definition, a planogram provides specific positions, locations or arrangements of each stocked item on the shelves of a shelf structure or in a container. In another definition, a planogram is a diagram or model that indicates the position, placement or arrangement of stocked items on the shelves of a shelf structure or in a container. The store clerks can also manually place, transfer, or move ESL display devices as they restock and adjust inventory on the retail shelves.

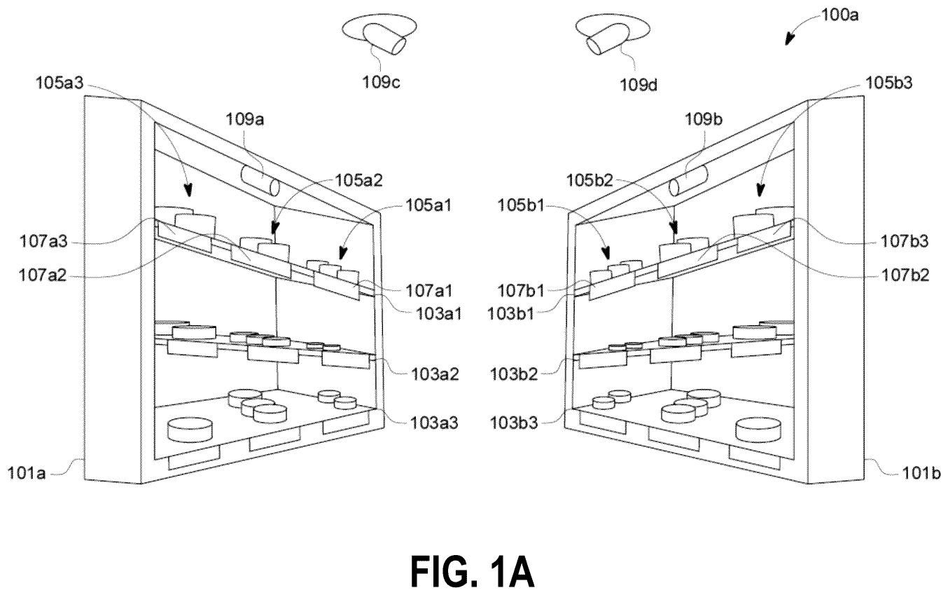

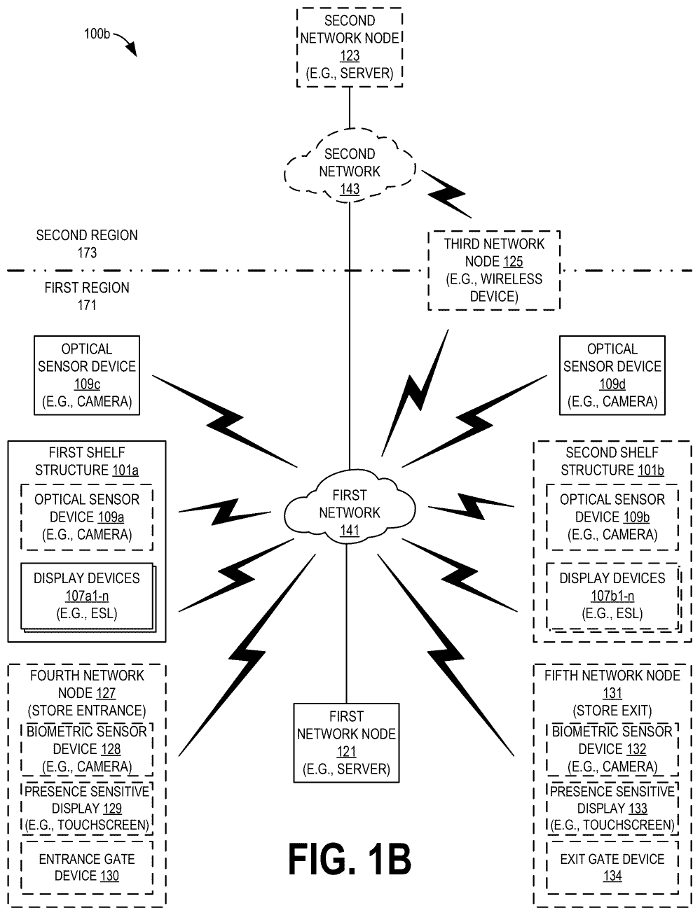

FIGS. 1A-B illustrate one embodiment of a frictionless system 100a,b operable to enable frictionless shopping in accordance with various aspects as described herein. As shown in FIGS. 1A-1B, the system 100a,b can include a first network node 121 (e.g., server) associated with a first region 171 (e.g., retail store, shelf structure, frictionless store) and communicatively coupled over a first network 141 (e.g., Ethernet, WiFi, LAN) and a second network 143 (e.g., WAN, Internet) to a second network node 123 (e.g., server) associated with a second region 173 (e.g., set of retail stores, geographical region) that includes the first region 171. In one example, the first region 171 is associated with a certain frictionless store and the second region 173 is associated with a set of frictionless stores that includes the certain frictionless store. In another example, the first region 171 is associated with a certain shelf structure and the second region 173 is associated with a frictionless store that includes the certain shelf structure. In yet another example, the first region 171 is associated with a certain frictionless store and the second region 173 is associated with a set of frictionless stores (including the certain retail store) in a certain geographical region (e.g., zip code, state, Southeast United States). Each shelf structure 101a,b includes shelves 103a1-3, 103b1-3 with each shelf 103a1-3, 103b1-3 having a portion of a set of stocked items (including stocked items 105a1-3, 105b1-3) with any of the same stocked items 105a1-3, 105b1-3 being transversely arranged on that shelf 103a1-3, 103b1-3.

Furthermore, the first network node 121 can be communicatively coupled over the first network 141 in the first region 171 to a set of display devices 107a1-n (e.g., ESL display devices) of a first shelf structure 101a and a set of display devices 107b1-n (e.g., ESL display devices) of a second shelf structure 101b as well as to optical sensor devices 109a-d (e.g., scanner, camera). Each optical sensor device 109a,b can be disposed on the corresponding shelf structure 101a,b. In one example, each optical sensor device 109a,b can be mounted at the edge of a certain shelf of the corresponding shelf structure 109a,b. In another example, each optical sensor device 109a,b can be mounted on the corresponding shelf structure 109a,b that is about four to five feet above the bottom of the corresponding shelf structure 109a,b. The first shelf structure 101a can be positioned opposite to or offset from the second shelf structure 101b so that the optical sensor device 109a disposed on the first shelf structure 101a can be configured with a field of view towards the shelves 103b1-3 of the second shelf structure 101b. Similarly, the second shelf structure 101b can be positioned opposite to or offset from the first shelf structure 101a so that the optical sensor device 109b disposed on the second shelf structure 101b can be configured with a field of view towards the shelves 103a1-3 of the first shelf structure 101a.

Alternatively or additionally, the optical sensor devices 109c,d can replace or be configured to contemporaneously capture images at different viewing angles of the corresponding optical sensor devices 109a,b of the first and second shelf structures 101a,b. For instance, the first network node 121 can be configured to receive image data of images contemporaneously captured at different viewing angles by each optical sensor device 109a,c of the shelf structure 101b. The first network node 121 can then determine the current arrangement information of the stocked items 105b1-n and the corresponding display devices 107b1-n on the shelves 103b1-3 of the shelf structure 101b based on the captured images by the optical sensor devices 109a,c. Further, the optical sensor devices 109c,d can be disposed on a wall, ceiling, or vertical structure. The optical sensor device 109c can be configured with a field of view towards the shelves 103b1-3 of the second shelf structure 101b. Similarly, the optical sensor device 109d can be configured with a field of view towards the shelves 103a1-3 of the first shelf structure 101-a.

In FIGS. 1A-B, each display device 107a1-an, 107b1-n can be configured to display information such as stocked item information (e.g., price) in visual form on a display element such as electronic paper (E-paper), liquid-crystal display (LCD), a light emitting diode (LED) display, or the like. Further, each display device 107a1-n, 107b1-n can be configured to enable an auditory (e.g., beep) or visual indication (e.g., blinking display). Each display device 107a1-n, 107b1-n can be configured as a small form factor (e.g., 3″ to 10″ wide by 2″ to 5″ high), battery-powered display that displays product or pricing information at the shelf edge of the shelf structure 101a,b. Further, each display device 107a1-n, 107b1-n can be configured to use wireless technology (e.g., WiFi, Bluetooth, LoRa) to communicate with the first network node 121 over the network 141. The stocked item information can include a visual unique identifier code (e.g., barcode, QR code), product price, stock identifier, product name, product image, the like, or any combination thereof. The visual unique identifier code 153 can represent one of the set of unique identifiers (e.g., UPCs), with each identifier being specific to a certain stocked item and represented by a series of characters (e.g., numeric characters, alphabetic characters, alphanumeric characters). Universal Product Code (UPC), which can refer to UPC-A, can include a sequence of twelve characters (e.g., 12 numeric characters) that are uniquely assigned to each stocked item. Along with the related International Article Number (EAN) barcode, the UPC is the barcode mainly used for scanning of stocked items at the point of sale, per the specifications of the international GS1 organization. In one example, a UPC-A barcode can be a sequence of twelve characters (e.g., 12 digits), which can be made up of four sections: a number system character, a five-character manufacturing number, a five-character item number and a check character.

In the current embodiment, the first network node 121 can be communicatively coupled over the first network 141 in the first region 171 to a fourth network node 127 operable to enable access to the first region 171. The fourth network node 127 can be configured to include a biometric sensor device 128 (e.g., camera, fingerprint scanner, retina scanner), a presence sensitive display 129 (e.g., touchscreen), an entrance gate device 130 operable to control an entrance gate, the like, or any combination thereof. The biometric sensor device 128 and the presence sensitive display 129 can be positioned at or about an outside perimeter of the first region 171 proximate an entrance portal (e.g., door) to the first region 171 (e.g., frictionless store). The entrance gate device 130 can be proximate the entrance portal to the first region 171 and can be operable to activate (e.g., unlock, open) or deactivate (e.g., lock, close) the entrance gate to enable entry to the first region 171. In addition, the first network node 121 can be communicatively coupled over the first network 141 in the first region 171 to a fifth network node 131 operable to enable checkout and/or exit from the first region 171. The fifth network node 127 can be configured to include a biometric sensor device 132 (e.g., camera, fingerprint reader, retina scanner), a presence sensitive display 133 (e.g., touchscreen), an exit gate device 134 operable to control an exit gate to enable exit, the like, or any combination thereof. The biometric sensor device 128 and the presence sensitive display 129 can be positioned at or about an inside perimeter of the first region 171 proximate the exit gate device 134 or an exit portal (e.g., door) from the first region 171. The exit gate device 134 can be proximate the exit portal and can be operable to activate (e.g., unlock, open) or deactivate (e.g., lock, close) the exit gate to enable exit from the first region 171. The entrance and exit portals of the first region 171 can be the same or separate portals

In FIGS. 1A-B, each optical sensor device 109a-d can include an image scanner or camera. An image scanner can be operable to optically scan images or printed text or objects and convert them to a digital image. A camera can be operable to capture an image. Further, a camera can be configured to be low, mid or high resolution, narrow or wide angle, fixed focus or autofocus, or the like depending on the specific application. In one example, each optical sensor device 109a-d can include a high resolution, wide angle, autofocus camera.

Furthermore, the first network node 121 can also be configured to improve the operational efficiency and customer experience in the frictionless store 100a. The first network node 121 can be configured to process data locally within the store 100a, reducing latency and improving response times for applications such as point of sale (POS) systems, inventory management, and customer relationship management (CRM) tools. Further, the first network node 121 can be configured to collect and analyze data from various sensors and devices deployed throughout the store 100a, including IoT devices, entry/exit gate terminals 127, 131, optical sensor devices 109a-d of a vision tracking system, self-checkout stations, cashier-performed checkout stations, surveillance cameras, and the vision tracking system to enable real-time insights into customer behavior, foot traffic patterns, and inventory levels. The first network node 121 can be configured to perform all or a portion of the functions of a vision tracking system. Further, the optical sensor devices 109a-d can be configured to perform all or a portion of the functions of a vision tracking system. The first network node 121 can also be configured to utilize display devices 107a1-n, 107b1-n, digital signage, promotional displays, and interactive kiosks to engage customers such as delivering multimedia content locally, ensuring smooth playback and reducing dependence on external network bandwidth. In addition, the first network node 121 can be configured to process video feeds provided by the optical sensor devices 109a-d, security cameras and surveillance systems, perform tasks such as facial recognition, license plate recognition and anomaly detection, and generate alerts for security breaches or suspicious activities in real-time. Additionally, the first network node 121 can be configured to track inventory movements in real-time, update inventory databases, and trigger alerts for low stock levels, enabling timely replenishment and reducing out-of-stock situations. The first network node 101 can also enable personalized customer experiences by analyzing historical data and current interactions such as recommending products based on past purchases or browsing behavior, enhancing cross-selling opportunities. The first network node 121 can also operate autonomously to ensure that essential functions such as POS transactions and security monitoring remain uninterrupted.

Each entry/exit gate device 130, 134 can include an optical scanner or sensor device 128, 132 operable to scan or capture an image of an optical machine readable code (e.g., QR code, bar code) such as displayed on a display of a wireless device 125 (e.g., smartphone) of a customer to enable entry/exit by that customer to/from the frictionless store 100a. The vision tracking system of the store 100a can include the optical sensor devices 126a-d strategically positioned throughout the store 100a to cover areas where customers may move in the store 100a and to cover stocked items on the shelves of the shelf structures. Further, the vision tracking system can apply advanced computer vision algorithms to images captured by the optical image devices 126a-d to detect and track objects such as stocked items and subjects (e.g., shoppers, customers, associates, vendors, suppliers) in real-time. Such algorithms may include facial recognition or other identification methods to recognize and track individual subjects as they move through the store 100a, product recognition algorithms to identify and track stocked items to monitor inventory and subject selections, movement tracking algorithms to monitor the movement of subjects and stocked items within the store 100a, including picking up items, placing them back, and purchasing decisions. The vision tracking system can also be operationally coupled to or integrated with the first network node 121 to interface with store inventory systems and payment systems to track product availability and customer purchases. In addition, the vision tracking system can analyze customer behavior, traffic patterns, popular products, and other data to improve store layout, product placement, and overall customer experience.

In operation, the first network node device 121 (e.g., edge server) can obtain a current location of a subject (e.g., shopper, associate, vendor, supplier, group) or a wireless device (e.g., smartphone) of the subject in the first region 171 (e.g., frictionless store) based on image data received from at least one of a set of optical sensor devices 109a-d (e.g., cameras) or current location information received from the wireless device. Further, the first network node device 121 can obtain a location of a requested stocked item 105a1-3, 105b1-3 (e.g., retail item) on the corresponding shelf structure 101a,b based on a planogram of the retail space 171 that includes a location of each shelf structure 101a,b and a location of each stocked item 105a1-3, 105b1-3 on the corresponding shelf structure 101a,b. The first network node device 121 can verify that the certain stocked item 105a1-3, 105b1-3 is at that location on the corresponding shelf structure 101a,b as described by the planogram based on image data received from at least one of the set of optical sensor devices 109a-d. In addition, the first network node 121 can determine navigation information from the current location of the wireless device or the subject to the location of the certain stocked item 105a1-3, 105b1-3 on the corresponding shelf structure 101a,b based on the location of the certain stocked item on the corresponding shelf structure 101a,b, the planogram or the current location of the subject or the wireless device. In response, the first network node 121 can send, to the wireless device of the subject over the network, an indication that includes all or a portion of the navigation information. The first network node 121 can determine that the subject or the wireless device is approaching or is proximate the location of the certain stocked item on the corresponding shelf structure 101a,b based on image data received from at least one of the set of optical sensor devices 109a-d or current location information received from the wireless device of the subject. In response, the first network node 121 can send, to a first display device of a set of display devices 107a1-3, 107b1-3 (e.g., ESLs) that is associated with and proximate the certain stocked item that is electronically requested by the subject, over the network, an indication that includes a request to enable an auditory or visual indication. The first network node 121 can determine that the certain stocked item 105a1-3, 105b1-3 has been removed at the determined location on the corresponding shelf structure 101a,b by the subject. In response, the first network node 121 can send, to the first display device 107a1-3, 107b1-3 over the network, an indication that includes a request to disable the auditory or visual indication.

In another exemplary embodiment, the first, fourth and fifth nodes 121, 127, 131 can be the same node, separate nodes, or any combination thereof. In one example, the first, fourth and fifth nodes 121, 127, 131 are the same node. In another example, the fourth and fifth nodes 127, 131 are the same node.

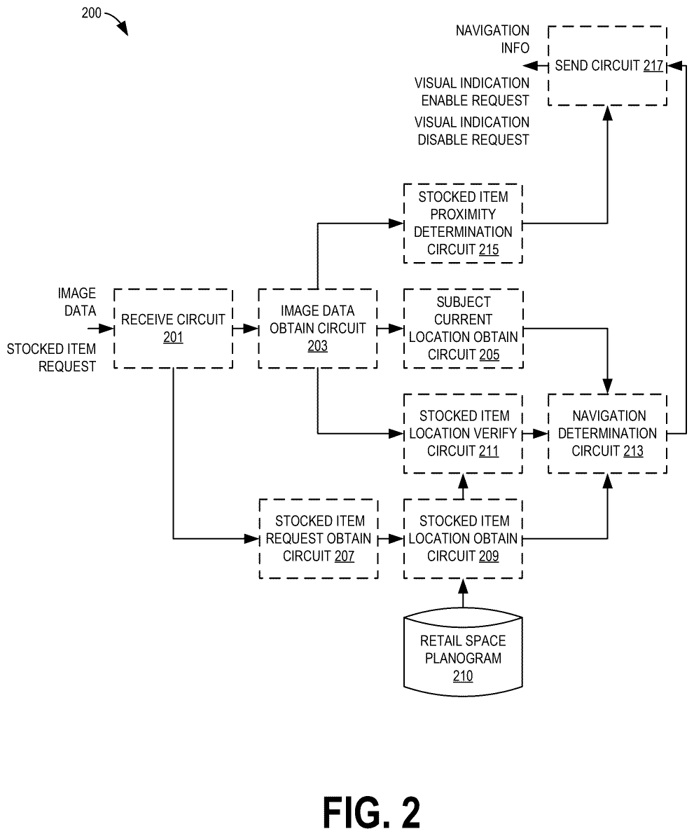

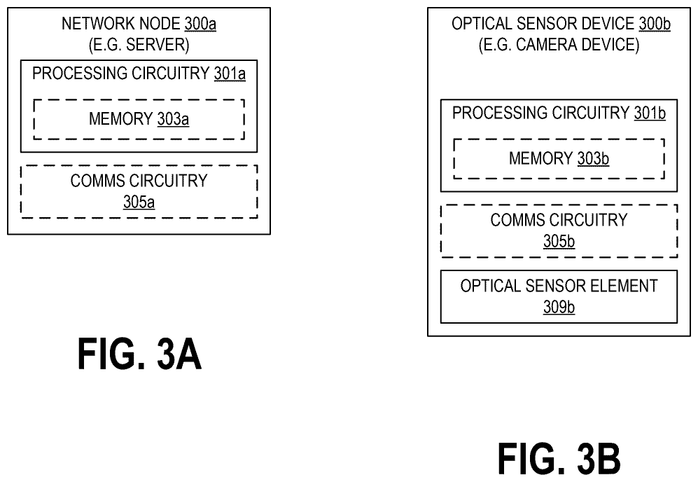

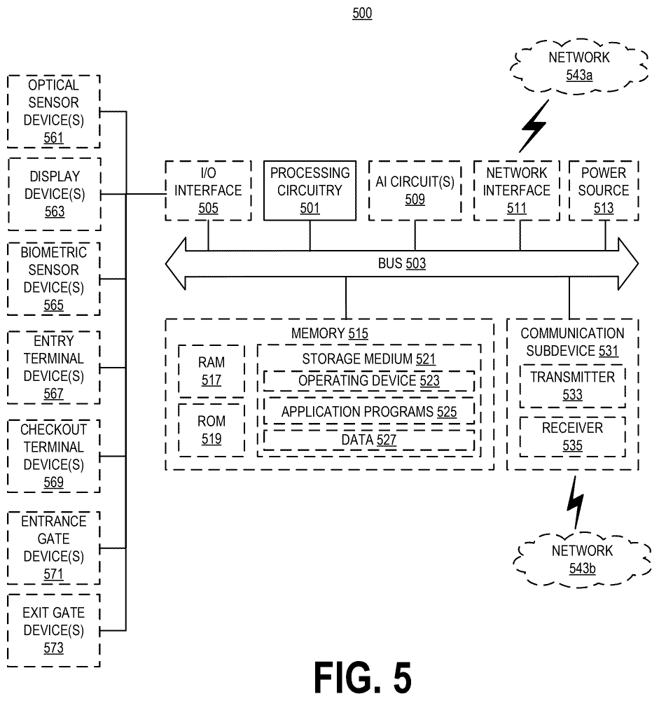

FIG. 2 illustrates another embodiment of a network node device 200 in accordance with various aspects as described herein. In FIG. 2, the device 200 implements various functional means, units, or modules (e.g., via the processing circuitry 301a in FIG. 3A, via the processing circuitry 501 in FIG. 5, via software code, or the like), or circuits. In one embodiment, these functional means, units, modules, or circuits (e.g., for implementing the method(s) described herein) may include for instance: a receive circuit 201a operable to receive information (e.g., image data, stocked item request information); an image data obtain circuit 203 operable to obtain data that represents an image; a subject current location obtain circuit 205 operable to obtain a current location of a subject or a wireless device; a stocked item request obtain circuit 207 operable to obtain a request to obtain the location of a certain stocked item; a stocked item location obtain circuit 209 operable to obtain a location of a certain stocked item on one of a set of shelf structures in the retail space based on a planogram 210 of the retail space configured to indicate a location of each stocked item on the set of shelf structures in the retail space; a stocked item location verify circuit 211 operable to verify the location of the certain stocked item based on image data captured by at least one of the set of optical sensors that has a viewing angle towards the corresponding shelf structure that has that stocked item; a navigation determination circuit 213 operable to determine navigation information from the current location of the subject to the location of the certain stocked item on the corresponding shelf structure in the retail space; a stocked item proximity determination circuit 215 operable to determine that the subject is approaching or proximate the certain stocked item on the corresponding shelf structure in the retail space; or a send circuit 217 operable to send information such as the navigation information, the visual indication enable request and the visual indication disable request.

FIG. 3A illustrates another embodiment of a network node device 300a (e.g., server) in accordance with various aspects as described herein. In FIG. 3A, the device 300a may include processing circuitry 301a that is operably coupled to one or more of the following: memory 303a, network communications circuitry 305a, or the like. The network communication circuitry 305a is configured to transmit or receive information to or from one or more other devices via any communication technology. The processing circuitry 301a is configured to perform processing described herein, such as by executing instructions stored in memory 303a. The processing circuitry 301a in this regard may implement certain functional means, units, or modules.

FIG. 3B illustrates another embodiment of an optical sensor device 300b (e.g., camera device) in accordance with various aspects as described herein. In FIG. 3B, the device 300b may include processing circuitry 301b that is operably coupled to one or more of the following: memory 303b, network communications circuitry 305b, an optical sensor element 309b (e.g., scanner, camera), or the like. The network communication circuitry 305b is configured to transmit or receive information to or from one or more other devices via any communication technology. The processing circuitry 301b is configured to perform processing described herein, such as by executing instructions stored in memory 303b. The processing circuitry 301b in this regard may implement certain functional means, units, or modules.

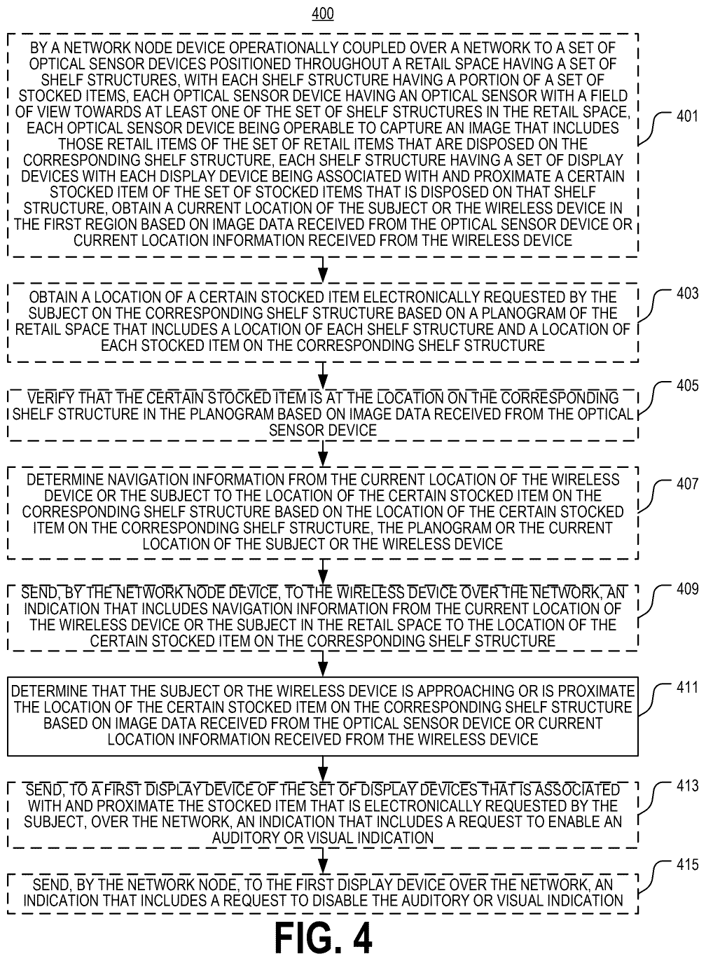

FIG. 4 illustrates one embodiment of a method 400 performed by a network node device of performing frictionless shopping in accordance with various aspects as described herein. In FIG. 4, the method 400 may start, for instance, at block 401 where it can include obtaining the current location of a subject (e.g., shopper, associate, vendor, supplier, group) or a wireless device associated with the subject in a retail space based on image data received from an optical sensor device or current location information received from the wireless device. At block 403, the method 300 can include obtaining a location of the certain stocked item on the corresponding shelf structure in the retail space based on a planogram of the retail space that includes a location of each shelf structure in the retail space and a location of each stocked item on the corresponding shelf structure. At block 405, the method 400 can include verifying that the certain stocked item is at the location on the corresponding shelf structure in the planogram based on image data received from the corresponding optical sensor device. At block 407, the method 400 can include determining navigation information from the current location of the wireless device or the subject to the location of the certain stocked item on the corresponding shelf structure in the retail space based on the location of the certain stocked item on the shelf structure, the planogram or the current location of the subject or the wireless device. At block 409, the method 400 can include sending, by the network node device, to the wireless device over the network, an indication that includes navigation information from the current location of the wireless device or the subject to the location of the certain stocked item on the corresponding shelf structure in the retail space. At block 411, the method 400 can include determining that the subject or the wireless device is approaching or is proximate the location of the certain stocked item on the corresponding shelf structure in the retail space based on image data received from the optical sensor device or current location information received from the wireless device. In response, the method 400 can include sending, to a first display device of the set of display devices that is associated with and proximate the stocked item electronically requested by the shopper on the corresponding shelf structure in the retail space, over the network, an indication that includes a request to enable an auditory or visual indication, as represented by block 413. At block 415, the method 400 can include sending, by the network node, to the first display device over the network, an indication that includes a request to disable the auditory or visual indication.

FIG. 5 illustrates another embodiment of a frictionless system device, a network node device or an optical sensor device 500 in accordance with various aspects as described herein. In FIG. 5, device 500 includes processing circuitry 501 that is operatively coupled over bus 503 to input/output interface 505, artificial intelligence circuitry 509 (e.g., neural network circuit, machine learning circuit), network connection interface 511, power source 513, memory 515 including random access memory (RAM) 517, read-only memory (ROM) 519 and storage medium 521, communication subsystem 531, and/or any other component, or any combination thereof.

The input/output interface 505 may be configured to provide a communication interface to an input device, output device, or input and output device. The device 500 may be configured to use an output device via input/output interface 505. An output device may use the same type of interface port as an input device. For example, a USB port or a Bluetooth port may be used to provide input to and output from the device 500. The output device may be a speaker, a sound card, a video card, a display, a monitor, a printer, an actuator, a transducer 575 (e.g., speaker, ultrasound emitter), an emitter, a smartcard, another output device, or any combination thereof. The device 500 may be configured to use an input device via input/output interface 505 to allow a user to capture information into the device 500. The input device may include an optical sensor element 561 such as a scanner device (e.g., optical scanner device), a camera, or the like. The output device may include a display device 563. The input/output device may include a presence sensitive display 563 (e.g., touchscreen) having a capacitive or resistive touch sensor to sense input from a user. A sensor may be, for instance, an accelerometer, a gyroscope, a tilt sensor, a force sensor, a magnetometer, an optical or image sensor, an infrared sensor, a proximity sensor, a microphone, an ultrasound sensor, another like sensor, or any combination thereof. As shown in FIG. 500, the input/output interface 505 can be configured to provide a communication interface to components of the device 500 such as the optical sensor device(s) 561 (e.g., camera), the display devices 563 (e.g., touchscreen), a biometric sensor device 565 (e.g., camera, fingerprint scanner, retina scanner), an entry display device 567, a checkout terminal device 569, an entrance gate device 571, an exit gate device 573, a scanner, a scale associated with a scanner platform, a payment processing mechanism, a printer, a coupon slot mechanism, a cash acceptor mechanism, a light emitting device, keyboard, keypad, card reader, the like, or any combination thereof.

In FIG. 5, storage medium 521 may include operating system 523, application program 525, data 527, the like, or any combination thereof. In other embodiments, storage medium 521 may include other similar types of information. Certain devices may utilize all of the components shown in FIG. 5, or only a subset of the components. The level of integration between the components may vary from one device to another device. Further, certain devices may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In FIG. 5, the artificial intelligence circuitry 509 may be configured to learn to perform tasks by considering examples such as performing object detection, classification or identification based on image data of an image. In one example, a first artificial intelligence circuitry is configured to perform object detection or classification. Further, a second artificial intelligence circuitry is configured to perform object identification. In FIG. 5, the network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers. The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the storage medium 521 may be configured to include an operating system 523, an application program 525 such as web browser, web application, user interface, browser data manager as described herein, a widget or gadget engine, or another application, and a data file 527. The storage medium 521 may store, for use by the device 500, any of a variety of various operating systems or combinations of operating systems.

The storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The storage medium 521 may allow the device 500a-b to access computer-executable instructions, application programs or the like, stored on transitory or non-transitory memory media, to off-load data, or to upload data. An article of manufacture, such as one utilizing a communication system may be tangibly embodied in the storage medium 521, which may comprise a device readable medium.

The processing circuitry 501 may be configured to communicate with network 543b using the communication subsystem 531. The network 543a and the network 543b may be the same network or networks or separate network or networks. The communication subsystem 531 may be configured to include one or more transceivers used to communicate with the network 543b. For example, the communication subsystem 531 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software, or firmware, or alternatively may be implemented separately.

In FIG. 5, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the device 500a-b.

The features, benefits and/or functions described herein may be implemented in one of the components of the device 500 or partitioned across multiple components of the device 500. Further, the features, benefits, and/or functions described herein may be implemented in any combination of hardware, software, or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

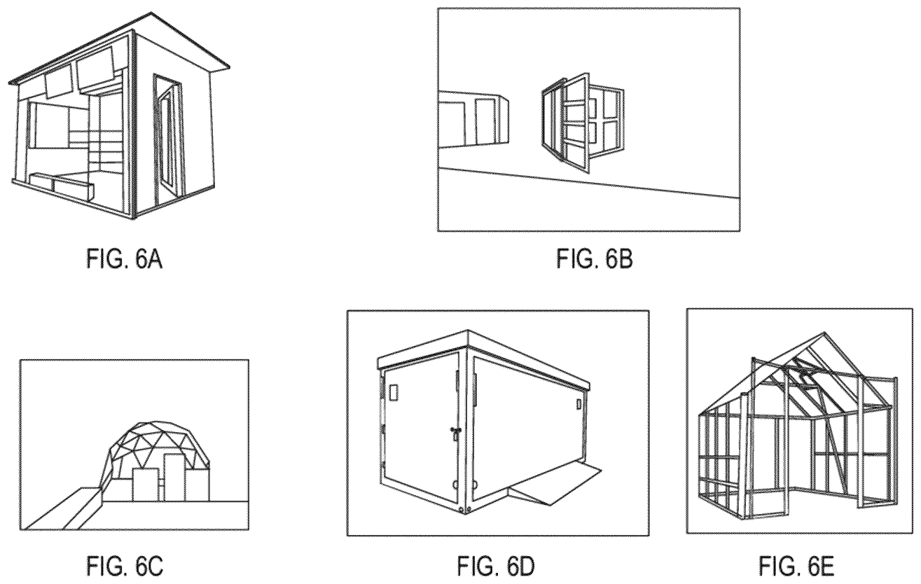

FIGS. 6A-6E illustrate various embodiments of a frictionless store in accordance with various aspects as described herein. In FIG. 6A, the frictionless store can include an exit/entry portal, display devices, or the like. In FIG. 6B, the frictionless store is converted from a shipping container and can include an exit/entry portal. In FIG. 6C, the frictionless store is configured as a dome structure (e.g., igloo) having an exit/entry portal. In FIG. 6D, the frictionless store is converted from a shipping container (e.g., rectangular shipping container). In FIG. 6E, the frictionless store is configured as a greenhouse structure operable to produce organic items (e.g., plants, fruits, vegetables) and can include an exit/entrance portal.

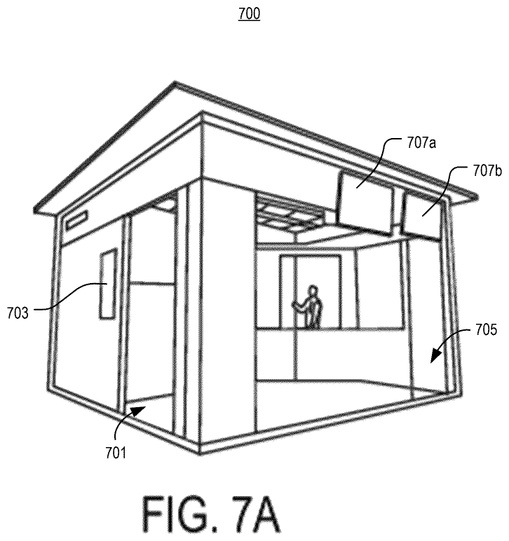

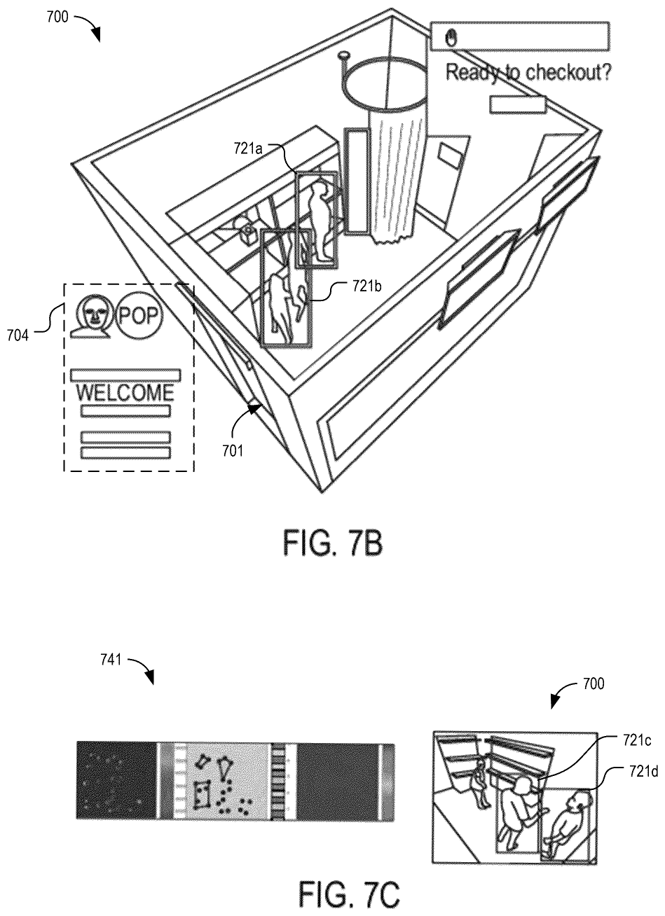

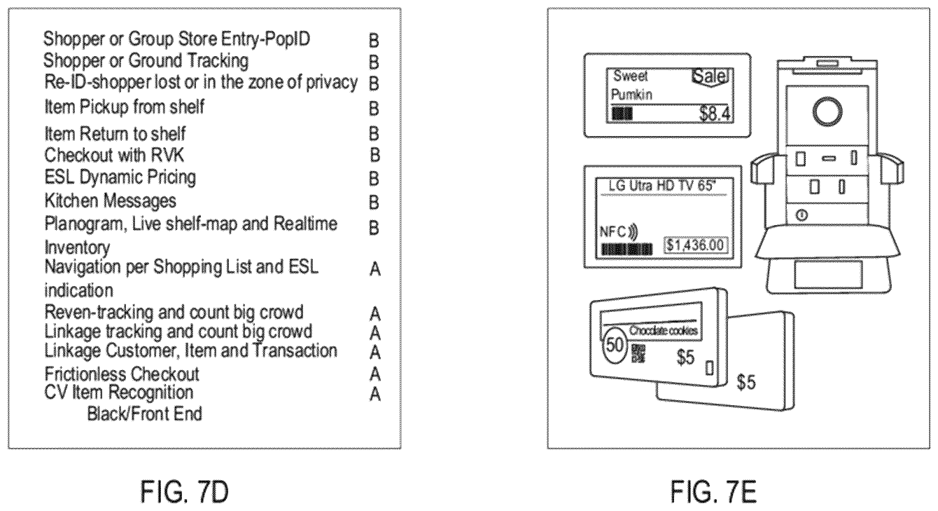

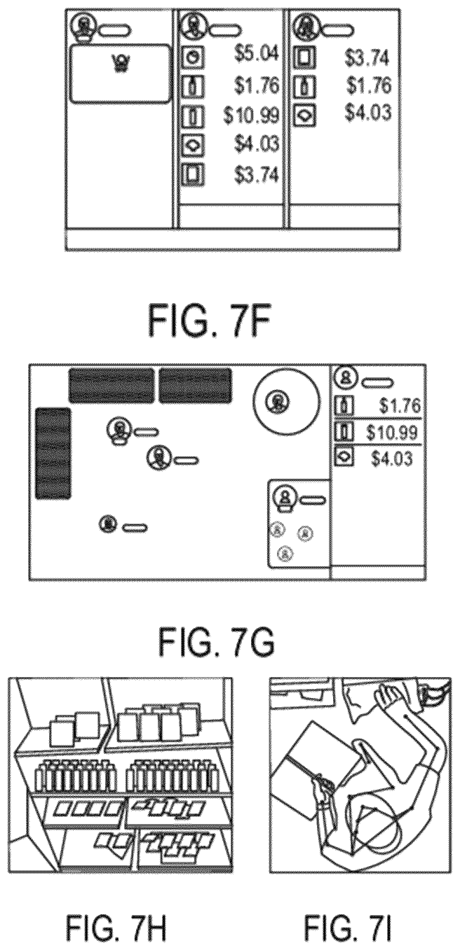

FIG. 7A further illustrates another embodiment of a frictionless store 700 in accordance with various aspects as described herein. In FIG. 7A, the frictionless store 700 can be configured to include a secured entry portal 701 (e.g., door, gate), an entry display device 703 operable to enable a subject (e.g., customer, store personnel, vendor, group) to enter the frictionless store 700 via the secured entry portal 701, an exit portal 705 (e.g., door, gate), one or more display devices 707a,b operable to display information associated with the frictionless store 700, or the like.

FIG. 7B further illustrates the frictionless store of FIG. 7A. The entry display device 703 is operable to display a visual representation 704 configured to enable authentication of a subject or a group of subjects based on biometric information of the subject for entry to the frictionless store 700. A skilled artisan will readily recognize various techniques for authenticating a subject. Once authenticated, the subject or group of subjects can enter the frictionless store 700a via the entry portal 701. The frictionless system via a vision tracking system can track each subject 721a or group of subjects 721b as they traverse the frictionless store 700 such as by obtaining a segmentation mask for each subject or group of subjects based on images captured by the vision tracking system.

FIG. 7C illustrates various information 741 obtained by the vision tracking system to determine segmentation masks for each tracked subject or group 721c, 721d. Further, the frictionless system can perform certain functions such as outlined in FIG. 7D for each tracked subject or group 721c, 721d. In addition, each retail item obtained by a subject or group member 721c, 721d can be tracked as illustrated in FIGS. 7E-7I.

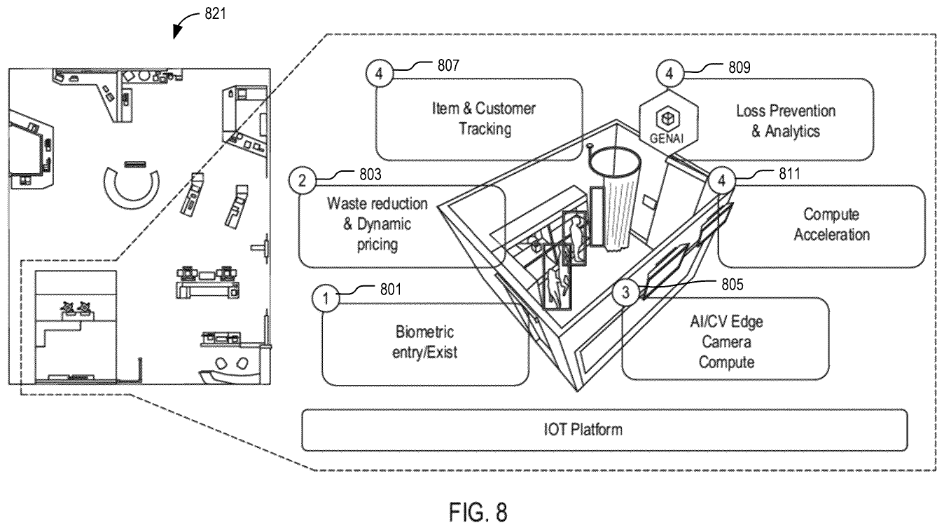

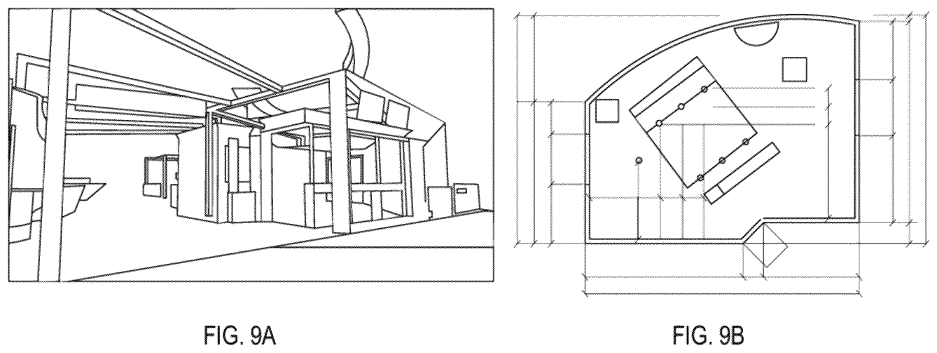

FIG. 8 illustrates another embodiment of a method 800 performed by a frictionless system of performing frictionless shopping in a frictionless store 821 in accordance with various aspects as described herein. In FIG. 8, the method 800 may start, for instance, at block 801 where the method 800 can include authenticating a subject via biometric information (e.g., facial recognition, fingerprint scan, retina scan) of that subject. At block 803, the method 800 can include performing waste reduction and/or dynamic pricing of the retail items in the frictionless store 821. At block 805, the method 800 can include performing video processing such as artificial intelligence/computer vision (AI/CV) edge camera computations. At block 807, the method 800 can perform subject and/or retail item tracking. At block 807, the method 800 can perform loss prevention and/or analytics. At block 809, the method 800 can accelerate the computations associated with any of blocks 801, 803, 805, 807.

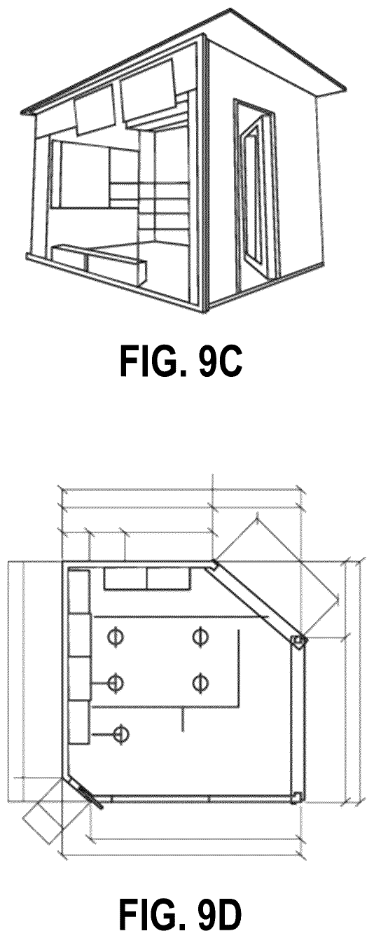

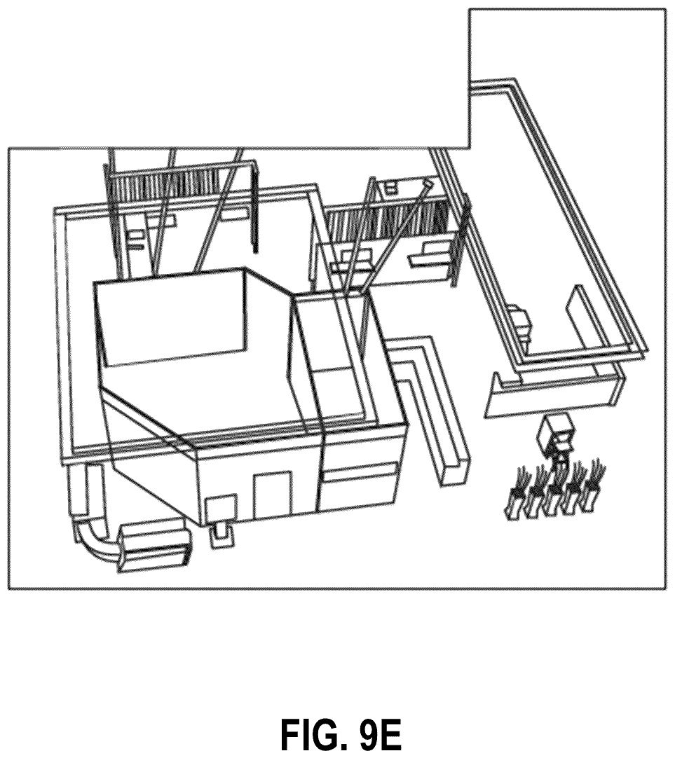

FIG. 9A is a perspective view of another embodiment of a frictionless store in accordance with various aspects as described herein. FIG. 9B is a plan view of the frictionless store of FIG. 9A. FIG. 9C is a perspective view of another embodiment of a frictionless store in accordance with various aspects as described herein. FIGS. 9D-9E are plan views of other embodiments of a frictionless store in accordance with various aspects as described herein.

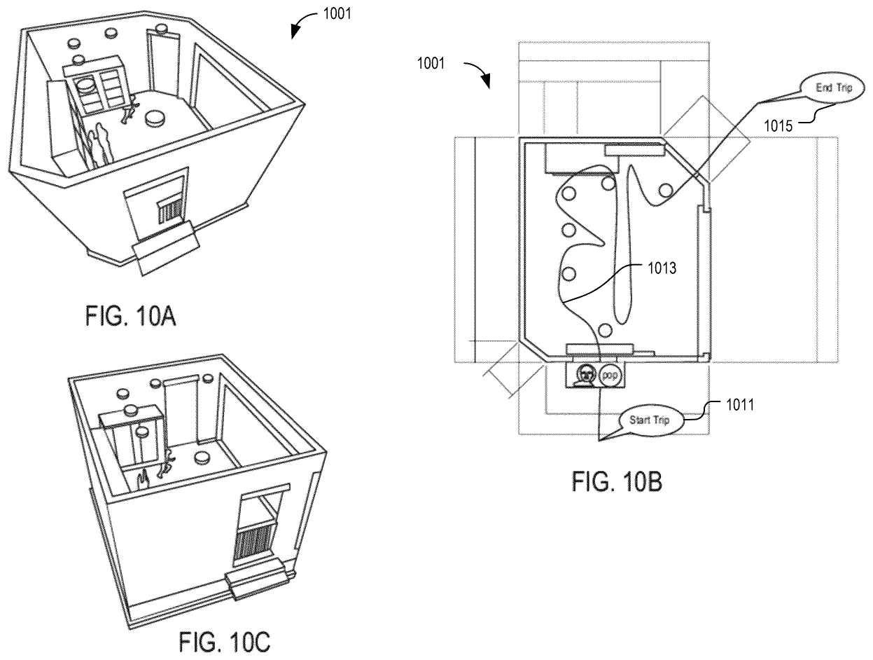

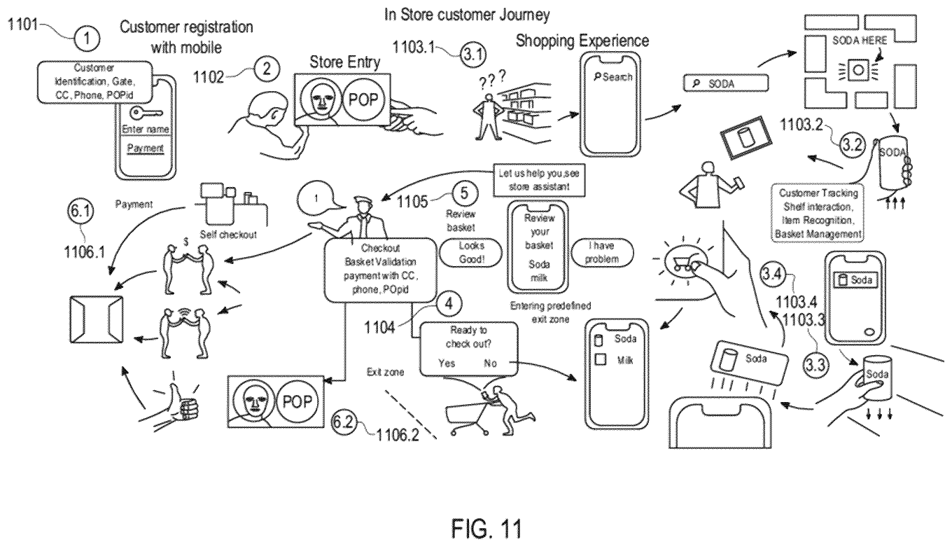

FIG. 10A is a perspective view of another embodiment of a frictionless store 1001 in accordance with various aspects as described herein. FIG. 10B is a plan view of the frictionless store 1001 of FIG. 10A. In FIG. 10A, a subject may start a visit to the frictionless store 1001 at point 1011. At or about point 1011, the subject can be authenticated to enable entry to the frictionless store 1001. The frictionless system via the vision tracking system can track the subject as that subject traverses about the frictionless store 1001, as represented by movement track 1013. The subject can end the visit by exiting the frictionless store 1001, as represented by point 1015. FIG. 10C is a perspective view of another embodiment of a frictionless store in accordance with various aspects as described herein.

FIG. 11 illustrates another embodiment of a method 1100 of performing frictionless shopping in a frictionless store in accordance with various aspects as described herein. In FIG. 11, the method 1100 may start, for instance, at block 1101 where it may include receiving, by a frictionless system of the frictionless store, from a wireless device of a subject over a network, an indication that includes registration information associated with the frictionless store, with the wireless device being operable to execute a registration application associated with the frictionless store. The registration information of the subject may include a customer identification, a frictionless store identifier, biometric information (e.g., facial image, fingerprint scan, retina scan), a phone number, an address, a secure digital identifier (e.g., POPid), payment information, or the like. At block 1102, the method 1100 can include authenticating the subject based on biometric information of the subject captured by an entry display device of the frictionless store and the biometric information obtained during the registration of the subject. At block 1103.1, the method 1100 can include receiving, by the frictionless system (e.g., first network node 121 of FIG. 1B), from the wireless device of the subject over the network, a requested retail item or a shopping list of retail items. Further, the method 1100 can include sending, by the frictionless system, to a first display device of the set of display devices (e.g., ESLs) that is associated with and proximate the requested retail item, over the network, an indication that includes a request to enable an auditory or visual indication so that the requested retail item can be located on a corresponding shelf structure in the retail space based on the auditory or visual indication. At block 1103.2, the method 1100 can include tracking activities of the subject including subject movement tracking, shelf structure interaction, retail item interaction, shopping basket interaction, or the like. At block 1103.3, the method 1100 can include determining that a requested retail item has been obtained by the subject and in response, can include sending, to the wireless device of the subject, an indication that the requested retail item has been obtained by the subject. At block 1103.4, the method 1100 can include receiving, by the frictionless system, from the wireless device of the subject over the network, an indication that includes a request to checkout the obtained retail item. In response, the method 1100 can send, by the frictionless system, to the wireless device of the subject over the network, an indication that includes a request to confirm that the obtained retail item is ready to be checked-out, as represented by block 1104. In response, the method 1100 can receive, by the frictionless system, from the wireless device of the subject over the network, an indication that includes an acknowledgement that the obtained retail item is ready to be checked-out. Additionally or alternatively, the method 1100 can determine that the subject is about a predetermined exit zone associated with checkout and in response, can commence the checkout of the obtained retail item. At block 1105, the method 1100 can include reviewing the shopping basket of the subject to validate the obtained retail item based on images captured by the vision tracking system. At block 1106.1, the method 1100 can include completing a financial transaction associated with the obtained retail item based on payment information associated with the subject. At block 1106.2, the method 1100 can include sending, by the frictionless system, to a network node that maintains a database that includes payment information of a set of registered subjects, over the network, an indication that includes a request for the payment information of the subject and that includes biometric information or the POPid of the subject to enable the network node to authenticate the subject. In response, the method 1100 can include receiving, by the frictionless system, from the network node over the network, an indication that includes the payment information of the subject. In response to completing payment of the transaction, the method 1100 can send, by the frictionless system, to an electronic device configured to operate an exit gate, an indication that includes a request to activate (e.g., unlock, open) the exit gate.

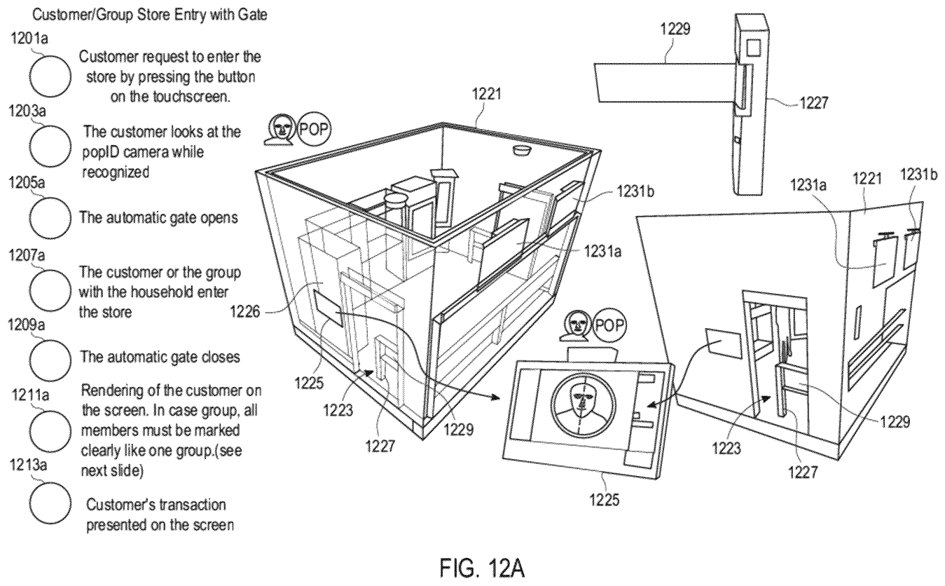

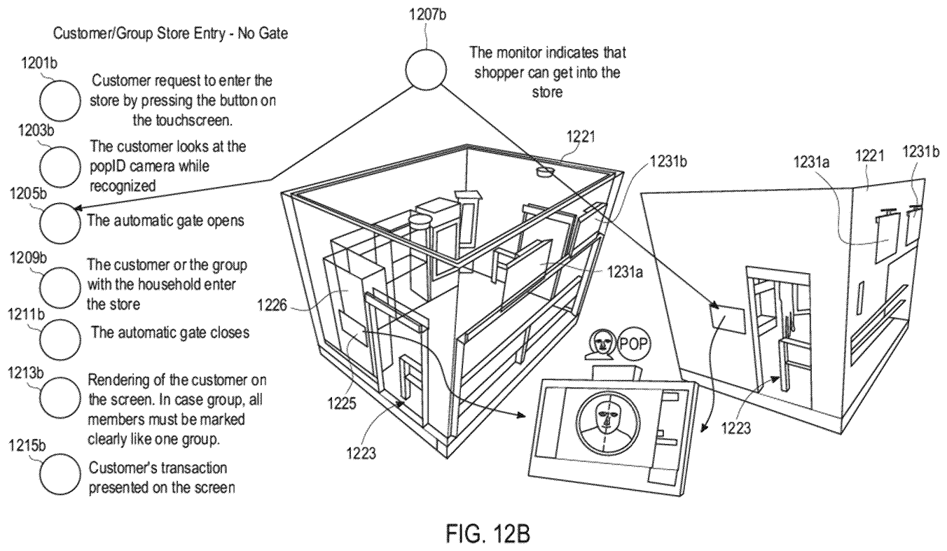

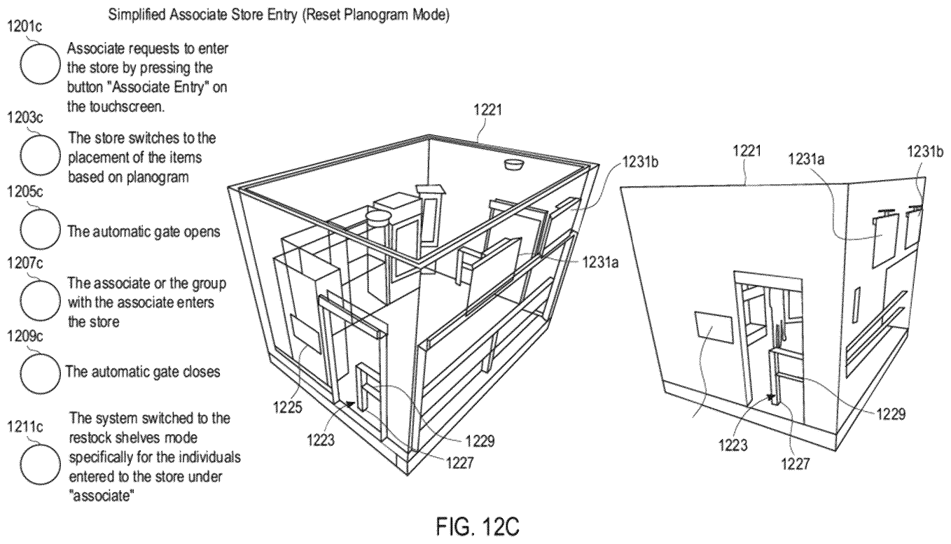

FIGS. 12A-12C illustrate other embodiments of a method 1200a-c of performing frictionless shopping in a frictionless store 1221 in accordance with various aspects as described herein. In FIG. 12A, the method 1200a can include outputting, by a frictionless system of the frictionless store 1221, to an entry display device 1225 (e.g., touchscreen) of the frictionless store 1221, a visual representation associated with a request by a subject (e.g., shopper, associate, vendor, supplier, group) to enter the frictionless store 1221 by pressing a designated virtual button on the entry display device 1225. Further, the method 1200a can include receiving, by the frictionless system, from the entry display device 1225, an indication that includes a request by a subject to enter the frictionless store 1221. In response, the method 1200a can include sending, to the entry display device 1225, by the frictionless system, an indication that includes a visual representation associated with a request to obtain biometric information (e.g., facial image, fingerprint scan, retina scan) of the subject via a biometric sensor device (e.g., camera, fingerprint reader, retina scanner) disposed with or proximate the entry display device 1225. At block 1203a, the method 1200a can include receiving, by the frictionless system, from the biometric sensor device, an indication that includes the captured biometric information of the subject. Further, the method 1200a can include authenticating the subject based on the captured biometric information of the subject and stored biometric information obtained such as during registration of the subject. In response, the method 1200a can include sending, by the frictionless system, to an entry gate device 1227 operable to control an entry gate 1229, an indication that includes a request to activate (e.g., unlock or open) the entry gate 1229, as represented by block 1205a. At block 1207a, the method 1200a can include tracking, by the frictionless system via its vision tracking system based on one or more images associated with the subject or group, the subject or group as the subject or group enters the store 1221 through entrance 1223 or passes through the entry gate 1229. At block 1209a, the method 1200a can include determining that the subject or group has passed through the entry gate 1229 and in response, can include sending, by the frictionless system, to the entry gate device 1227, an indication that includes a request to deactivate (e.g., lock, close) the entry gate 1229. At block 1211a, the method 1200a can include rendering a visual representation (e.g., facial image, POPid, other identifier) associated with the subject or each group member. The method 1200a can include sending or outputting, by the frictionless system, for display on one more display devices 1231a,b disposed in the frictionless store 1221, an indication that includes the rendered visual representation of the subject or group member. Further, the method 1200a can include tracking activities of the subject or group member as that subject or group member traverses the store 1221, including movement tracking, shelf structure interaction, retail item interaction, shopping basket interaction, or the like. In addition, the method 1200a can include determining that a certain retail item has been obtained by the subject or group member and in response, can include rendering a visual representation of the obtained retail item. At block 1213a, the method 1200a can include sending or outputting, by the frictionless system, for display on the one more display devices 1231a,b disposed inside, outside or about the frictionless store 1221, an indication that includes the rendered visual representation of the obtained retail item. In one example, the visual representation of the obtained retail item is rendered proximate the visual representation of the subject or group member that obtained that retail item. As such, the one or more display devices 1231a,b can display those retail items obtained by the subject, a group member, or the group.

In FIG. 12B, the method 1200b may start, for instance, at block 1201b where it can include outputting, by the frictionless system of the frictionless store 1221, to an entry display device 1225 (e.g., touchscreen) of the frictionless store 1221, a visual representation associated with a request by a subject (e.g., shopper, associate, vendor, supplier, group) to enter the frictionless store 1221 by pressing a designated virtual button on the entry display device 1225. Further, the method 1200b can include receiving, by the frictionless system, from the entry display device 1225, an indication that includes a request by the subject to enter the frictionless store 1221. In response, the method 1200b can include sending, to the entry display device 1225, by the frictionless system, an indication that includes a visual representation associated with a request to obtain biometric information (e.g., facial image, fingerprint scan, retina scan) of the subject via a biometric sensor device (e.g., camera, fingerprint scanner, retina scanner) disposed with or proximate the entry display device 1225. At block 1203b, the method 1200b can include receiving, by the frictionless system, from the biometric sensor device, an indication that includes the captured biometric information of the subject. Further, the method 1200b can include authenticating the subject based on the captured biometric information of the subject and stored biometric information of the subject obtained such as during registration by the subject. In response, the method 1200b can include sending, by the frictionless system, to an entry gate device 1227 operable to control an entry gate 1229, an indication that includes a request to activate (e.g., unlock or open) the entry gate 1229, as represented by block 1205b. Further, the method 1200b can include sending or outputting, by the frictionless system, to the entry display device 1225, an indication that includes a visual representation that indicates that the subject or group can enter the store 1221, as represented by block 1207b. At block 1209b, the method 1200b can include tracking, by the frictionless system via its vision tracking system, the subject or group as the subject or group enters the store 1221 through entrance 1223 and passes through the entry gate 1229. The method 1200b can include determining that the subject or group has passed through the entry gate 1229. In response, the method 1200b can include sending, by the frictionless system, to the entry gate device 1227, an indication that includes a request to deactivate (e.g., lock, close) the entry gate 1229, as represented by block 1211b. At block 1213b, the method 1200b can include rendering a visual representation (e.g., facial image, POPid, other identifier) associated with the subject or group member. The method 1200b can include sending or outputting, by the frictionless system, for display on one more display devices 1231a,b disposed inside, outside or about the frictionless store 1221, an indication that includes the rendered visual representation of the subject or group member. At block 1215b, the method 1200b can include tracking activities of the subject or group member as that subject or group member traverses the store 1221, including subject movement tracking, shelf structure interaction, retail item interaction, shopping basket interaction, or the like. Further, the method 1200b can include determining that a certain retail item has been obtained by the subject or group member and in response, can include rendering a visual representation of the obtained retail item. In addition, the method 1200b can include sending or outputting, by the frictionless system, for display on the one more display devices 1231a,b disposed inside, outside or about the frictionless store 1221, an indication that includes the rendered visual representation of the obtained retail item. In one example, the visual representation of the obtained retail item is rendered proximate the visual representation of the subject or group member that obtained that retail item. As such, the one more display devices 1231a,b display those retail items obtained by the subject, a group member, or the group.

In FIG. 12C, the method 1200c may start, for instance, at block 1201c where it can include outputting, by the frictionless system of the frictionless store 1221, to an entry display device 1225 (e.g., touchscreen) of the frictionless store 1221, a visual representation associated with a request by an associate (e.g., clerk, vendor, supplier) of the store 1221 to enter the store 1221 by pressing a designated virtual button on the entry display device 1225. Further, the method 1200c can include receiving, by the frictionless system, from the entry display device 1225, an indication that includes a request by the associate to enter the store 1221. In response, the method 1200c can include sending, to the store entry display device 1225, by the frictionless system, an indication that includes a visual representation associated with a request to obtain biometric information (e.g., facial image, fingerprint scan, retina scan) of the associate via a biometric sensor device (e.g., camera, fingerprint scanner, retina scanner) disposed with or proximate the entry display device 1225. Further, the method 1200c can include receiving, by the frictionless system, from the biometric sensor device, an indication that includes the captured biometric information of the associate. In addition, the method 1200c can include authenticating the associate based on the captured biometric information of the associate and stored biometric information associated with that associate. In response, the method 1200c can include switching placement of the set of retail items based on a planogram of the store 1221, as represented by block 1203c. At block 1205c, the method 1200c can include sending, by the frictionless system, to the entry gate device 1227, an indication that includes a request to activate (e.g., unlock or open) the entry gate 1229. At block 1207c, the method 1200c can include tracking, by the frictionless system via its vision tracking system, the associate as the associate enters the store 1221 through entrance 1223 or passes through the entry gate 1229. At block 1209c, the method 1200c can include determining that the associate has passed through the entry gate 1229 and in response, can include sending, by the frictionless system, to the entry gate device 1227, an indication that includes a request to deactivate (e.g., lock or close) the entry gate 1229. At block 1211c, the method 1200c can include sending or outputting, by the frictionless system, for display to each display device of the set of display devices (e.g., ESLs) that is associated with and proximate a corresponding retail item of the set of retail items disposed on the set of shelf structures, an indication that includes restocking information (e.g., SKU, available stock, restock required indicator, retail item name, retail item image) associated with the corresponding retail item based on planogram information of the store 1221.

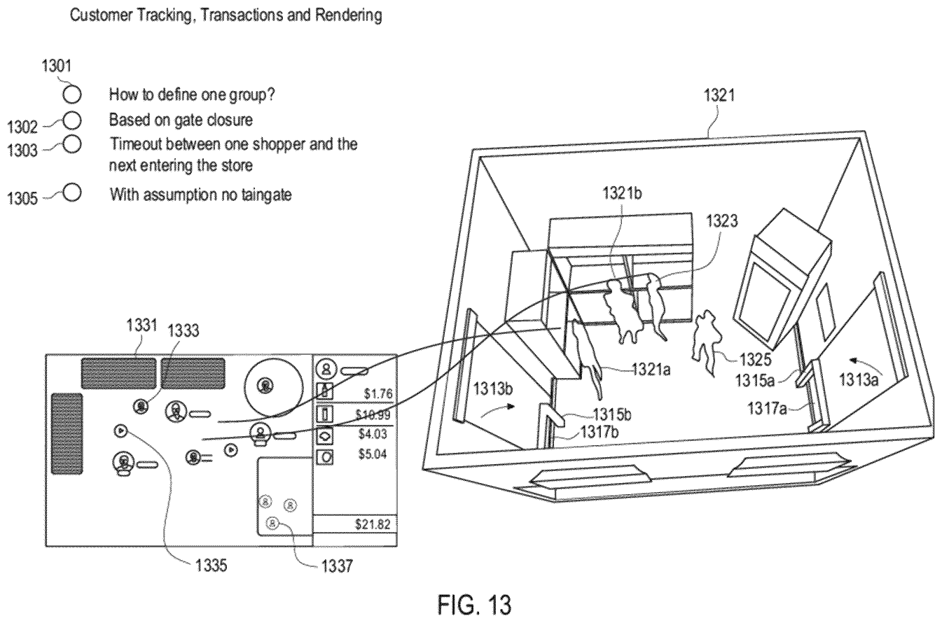

FIG. 13 illustrates one embodiment of a method 1300 of performing frictionless shopping in a frictionless store 1321 in accordance with various aspects as described herein. The store 1321 can include an entry gate device 1315a having an entry gate 1317a proximate an entrance portal 1313a. Further, the store 1321 can include an exit gate device 1315b having an exit gate 1317b proximate an exit portal 1313b. In FIG. 13, the method 1300 may start, for instance, at block 1301 where it can include defining a group 1321a,b that includes an authenticated subject 1321a,b. At block 1302, the method 1300 can include defining the group 1321a,b based on a time period associated with closure of an entry gate 1317a of an entry gate device 1315a at an entrance portal 1313a of the store 1321. At block 1303, the method 1300 can include defining the group based on a timeout period between subjects entering the store 1321 through the entrance portal 1313a or the entry gate 1317a. At block 1305, the method 1300 can include defining the group based on a timeout period between subjects entering the store 1321 through the entrance portal 1313a without an entry gate. The method 1300 can include tracking activities of a subject 1323, 1325 or group member 1321a,b as that subject 1323, 1325 or group member 1321a,b traverses the store 1321, including movement tracking, shelf structure interaction, retail item interaction, shopping basket interaction, or the like. Further, the method 1300 can include rendering a visual representation of elements of the store 1321 such as shelf structures 1331, a location 1337 of each subject 1337, a location 1335, 1333 of each group member 1321a,b, any retail items obtained by each subject 1323, 1325 or each group member 1321a-b, or the like. In addition, the method 1300 can include sending or outputting, by the frictionless system, for display on the one more display devices disposed inside, outside or about the frictionless store 1321, an indication that includes the rendered visual representation of those elements.

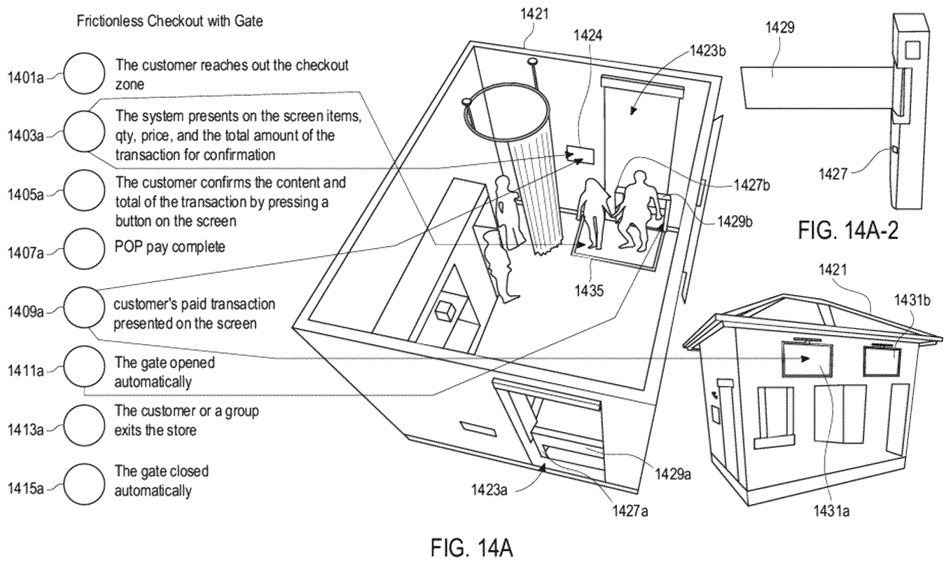

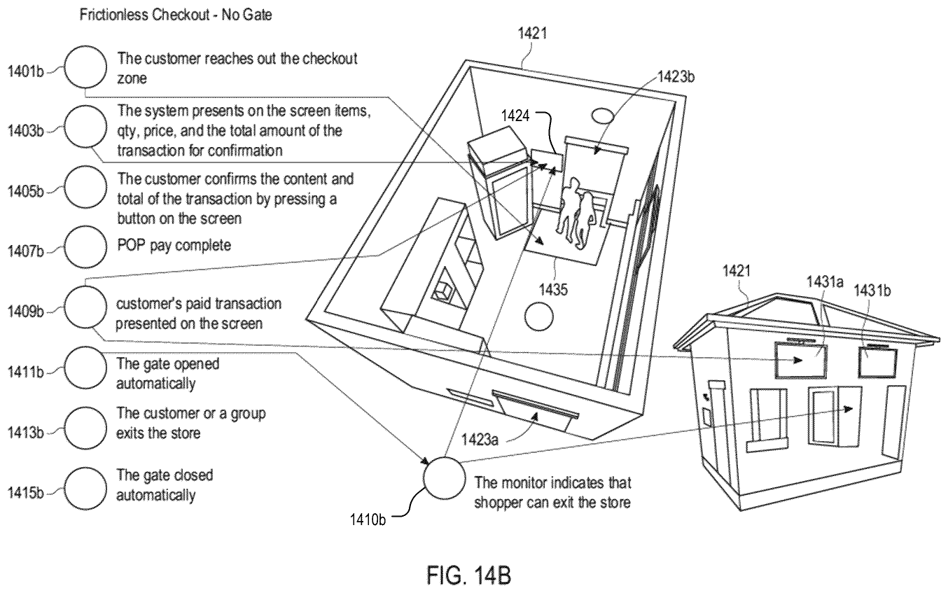

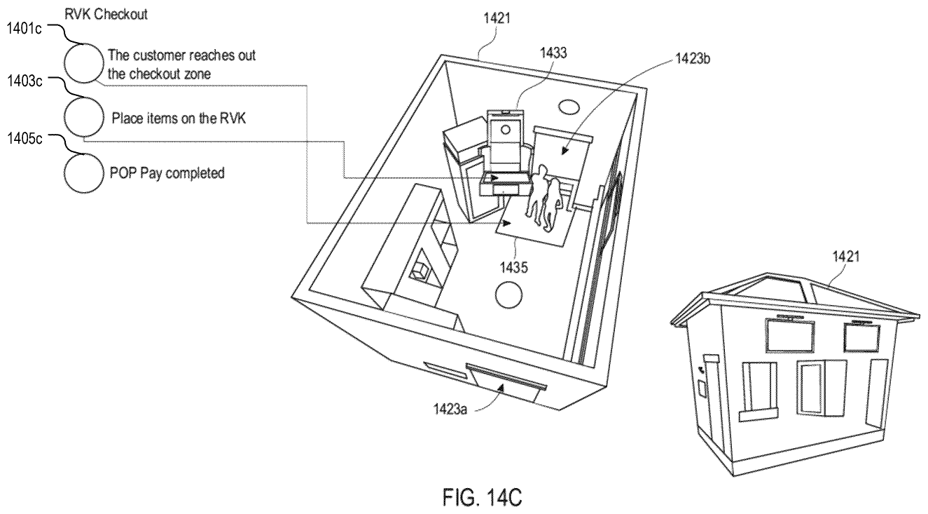

FIGS. 14A-14C illustrate embodiments of a method 1400a-c of performing frictionless shopping in a frictionless store 1421 in accordance with various aspects as described herein. The frictionless store 1421 can include entrance and exit portals 1423a,b, entry and exit gate devices 1427a,b operable to control corresponding entry and exit gates 1429a,b, a checkout terminal device 1424 (e.g., touchscreen), one or more display devices 1431a,b (e.g., monitors), or the like. In FIG. 14A, the method 1400a may start, for instance, at block 1401a where it can include determining that a subject is about a checkout region 1435 of the store 1421. At block 1403a, the method 1400a can include sending or outputting, by a frictionless system of the store 1421, for display by the checkout terminal device 1424, an indication that includes one or more retail items obtained by the subject in the store 1421, a quantity of each obtained item, a price of each obtained item, a total amount of the obtained items, and a visual representation of a request to confirm the transaction. At block 1405a, the method 1400a can include receiving, by the frictionless system, from the checkout terminal device 1424, an indication that includes confirmation of the displayed transaction. At block 1407a, the method 1400a can include completing payment of the transaction based on a secure digital identifier (e.g., POPid). At block 1409a, the method 1400a can include sending or outputting, by the frictionless system, for display by the checkout terminal device 1424 or the one or more display devices 1431a,b, an indication that includes a visual representation of the completed transaction. At block 1411a, the method 1400a can include sending, by the frictionless system, to the exit gate device 1427b, an indication that includes a request to activate (e.g., unlock, open) the exit gate 1429b to enable the subject to proceed through the exit 1423b. At block 1413a, the method 1400a can include enabling a group member to exit the store 1421 such as based on that group member being identified during entrance to the store 1421. At block 1415a, the method 1400a can include sending, by the frictionless system, to the exit gate device 1427b, an indication that includes a request to deactivate (e.g., lock or close) the exit gate 1429b.

In FIG. 14B, the method 1400b may start, for instance, at block 1401b where it can include determining that a subject is about a checkout region 1435. At block 1403b, the method 1400b can include sending or outputting, by a frictionless system of the store 1421, for display by the checkout terminal device 1424, an indication that includes one or more retail items obtained by the subject in the store 1421, a quantity of each obtained item, a price of each obtained item, a total amount of the obtained items, and a visual representation of a request to confirm the transaction. At block 1405b, the method 1400b can include receiving, by the frictionless system, from the checkout terminal device 1424, an indication that includes confirmation of the displayed transaction. At block 1407b, the method 1400b can include completing payment of the transaction based on a secure digital identifier (e.g., POPid). At block 1409b, the method 1400b can include sending or outputting, by the frictionless system, for display by the checkout terminal device 1424 or the one or more display devices 1431a,b, an indication that includes a visual representation of the completed transaction. At block 1410b, the method 1400b can include sending or outputting, by the frictionless system, for display by the exit display device 1424, an indication that includes a visual representation associated with the subject being enabled to exit the store 1421 via the exit 1423b. At block 1411b, the method 1400b can include sending, by the frictionless system, to the exit gate device 1427b, an indication that includes a request to activate (e.g., unlock, open) the exit gate 1429b to enable the subject to proceed through the exit 1423b. At block 1413b, the method 1400b can include enabling a group member to exit the store 1421 such as based on that group member being identified during entrance to the store 1421. At block 1415b, the method 1400b can include sending, by the frictionless system, to the exit gate device 1427b, an indication that includes a request to deactivate (e.g., lock or close) the exit gate 1429b.

In FIG. 14C, the method 1400c may start, for instance, at block 1401c where it can include determining that a subject is about a predetermined checkout region 1435. In response, the method 1400c can include sending or outputting, by a frictionless system of the store 1421, to a display device of a reverification kiosk (RVK) device 1433, an indication that includes a visual representation associated with a request to place obtained items on the RVK device 1433, as represented by block 1403c. In one example, the RVK device 1433 can be operable to secure or verify that retail items obtained by the subject are properly scanned, tracked, or accounted for before exiting the store 1421. At block 1405c, the method 1400c can include completing a transaction associated with the obtained items based on a secure digital identifier (e.g., POPid).

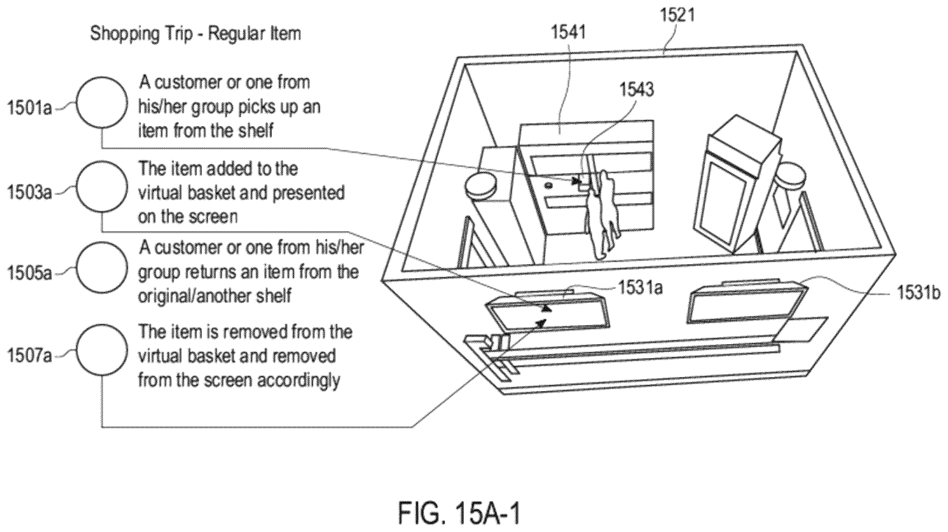

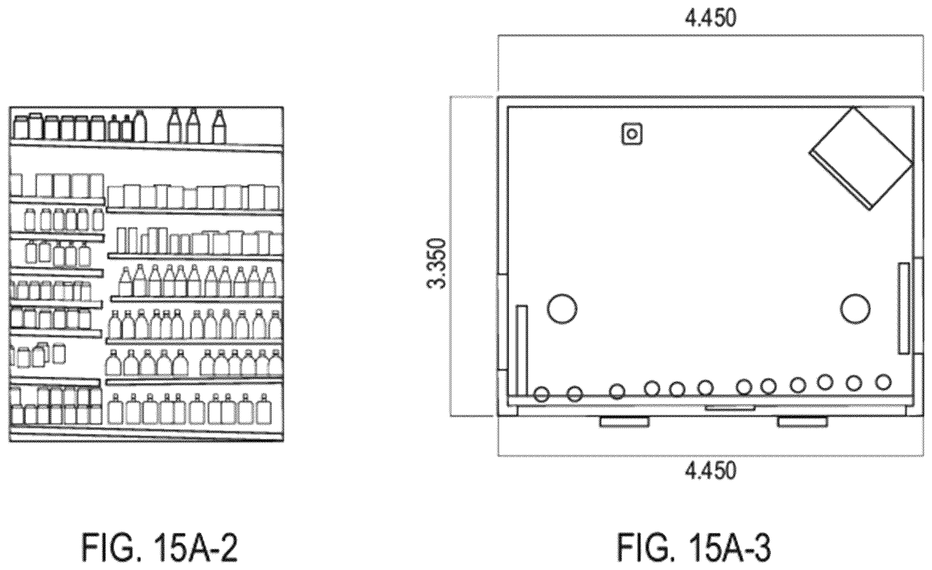

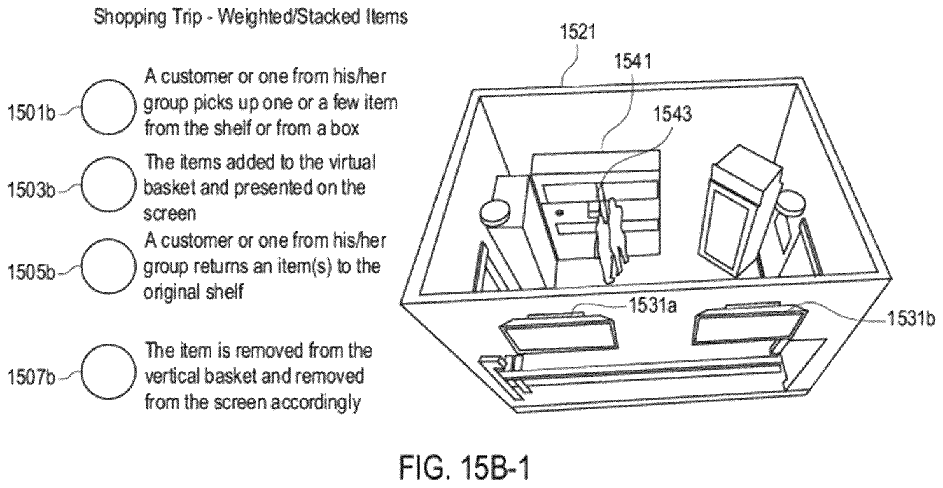

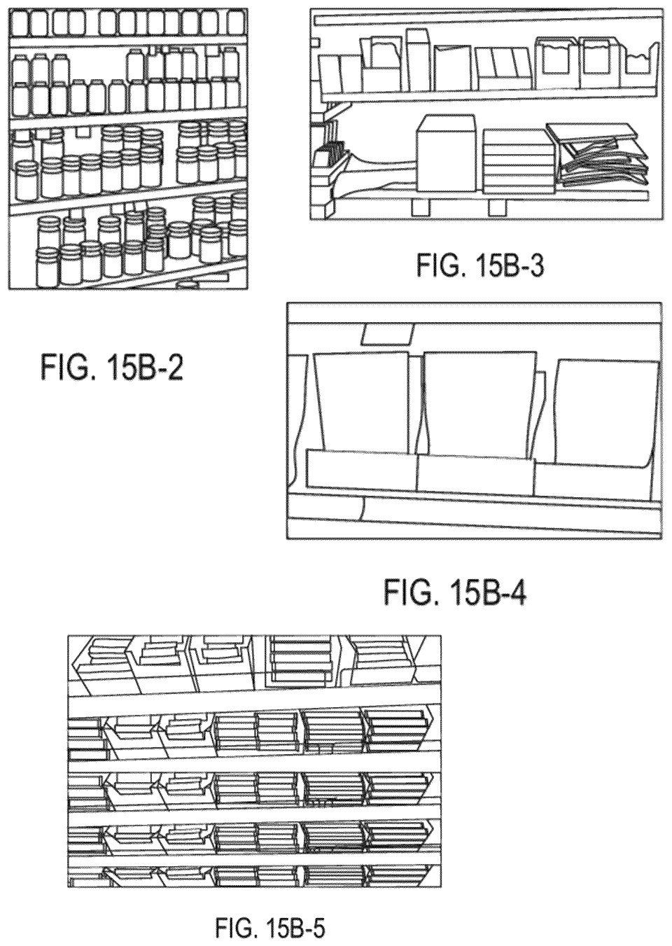

FIG. 15A-1 illustrates another embodiment of a method 1500a of performing frictionless shopping in a frictionless store 1521 in accordance with various aspects as described herein. In FIG. 15A-1, the method 1500a may start, for instance, at block 1501a where it can include detecting that a certain retail item 1543 of a set of retail items disposed on a shelf structure 1541 is removed from that shelf structure 1541 by a subject or group member based on one or more images captured by a vision tracking system of the frictionless system. At block 1503a, the method 1500a can include determining to add the certain retail item 1543 to a virtual shopping cart associated with the subject, the group member or the group. Further, the method 1500a can include rendering a virtual representation of the virtual shopping cart that includes the certain retail item 1543 and sending or outputting, by the frictionless system, for display by one or more display devices 1531a,b, an indication that includes the rendered virtual representation of the virtual shopping cart. At block 1505a, the method 1500a can include detecting that the subject or group member returned a retail item to the shelf structure 1541 or another shelf structure based on one or more images captured by the vision tracking system. In response, the method 1500a can include identifying the returned retail item based on one or more images captured by the vision tracking system. Further, the method 1500a can include determining that the returned retail item corresponds to a retail item in the virtual shopping cart. At block 1507a, the method 1500a can include removing that retail item from the virtual shopping cart to obtain an updated virtual shopping cart, rendering the updated virtual shopping cart based on the current retail items in the virtual shopping cart, and sending or outputting, by the frictionless system, for display by the one or more display devices 1531a,b, an indication that includes the rendered updated virtual shopping cart. FIG. 15A-2 illustrates an example of retail items disposed on a shelf structure in FIG. 15A-1. FIG. 15A-3 is a plan view of the frictionless store of FIG. 15A-1.

FIG. 15B-1 illustrates another embodiment of a method 1500b of performing frictionless shopping in a frictionless store 1521 in accordance with various aspects as described herein. In FIG. 15B-1, the method 1500b may start, for instance, at block 1501b where it can include detecting that a certain retail item 1543 of a set of retail items disposed on a shelf structure 1541 or a container (e.g., box) is removed from that shelf structure 1541 or that container by a subject or group member based on one or more images captured by a vision tracking system of the frictionless system. At block 1503b, the method 1500b can include determining to add the certain retail item 1543 to a virtual shopping cart associated with the subject, a group member or the group. Further, the method 1500b can include rendering a virtual representation of the virtual shopping cart that includes the certain retail item 1543 and sending or outputting, by the frictionless system, for display by one or more display devices 1531a,b, an indication that includes the rendered virtual representation of the virtual shopping cart. At block 1505b, the method 1500b can include detecting that the subject or group member returned a retail item to the shelf structure 1541, another shelf structure, the container or another container based on one or more images captured by the vision tracking system. In response, the method 1500b can include identifying the returned retail item based on one or more images captured by the vision tracking system. Further, the method 1500b can include determining that the returned retail item corresponds to a retail item in the virtual shopping cart. At block 1507b, the method 1500b can include removing that retail item from the virtual shopping cart to obtain an updated virtual shopping cart, rendering the updated virtual shopping cart based on the current retail items in the virtual shopping cart, and sending or outputting, by the frictionless system, for display by the one or more display devices 1531a,b, an indication that includes the rendered updated virtual shopping cart. FIG. 15B-2 to FIG. 15B-5 illustrate other examples of retail items disposed on a shelf structure in accordance with various aspects as described herein.

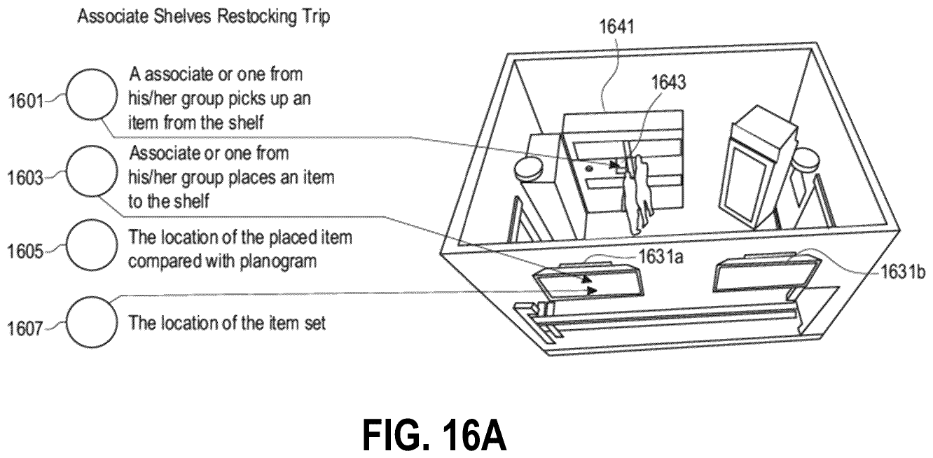

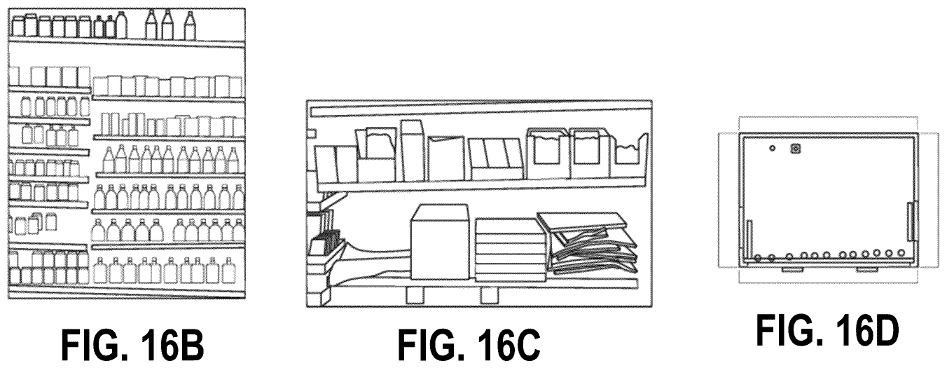

FIG. 16A illustrates another embodiment of a method 1600 of performing frictionless shopping in a frictionless store 1621 in accordance with various aspects as described herein. In FIG. 16A, the method 1600 may start, for instance, at block 1601 where it can include detecting that a certain retail item 1643 of a set of retail items disposed on a shelf structure 1641 is removed from that shelf structure 1641 by an associate or group member based on one or more images captured by a vision tracking system of the frictionless system. At block 1603, the method 1600 can include detecting that the associate or group member returns a retail item to the shelf structure 1641, another shelf structure or a container based on one or more images captured by the vision tracking system. In response, the method 1600 can include identifying the returned retail item based on one or more images captured by the vision tracking system. Further, the method 1600 can include determining a location on the shelf structure 1641, another shelf structure or a container on which the returned retail item is disposed based one or more images captured by the vision tracking system. The method 1600 can include rendering a virtual representation associated with the determined location of the returned retail item, and sending or outputting, by the frictionless system, for display by the one or more display devices 1631a,b, an indication that includes that rendered virtual representation. At block 1605, the method 1600 can include confirming that the location of the returned retail item corresponds a planogram of the store 1641. At block 1607, the method 1600 can include rendering a virtual representation associated with the confirmed location of the returned retail item, and sending or outputting, by the frictionless system, for display by the one or more display devices 1631a,b, an indication that includes that rendered virtual representation. FIGS. 16B-16C illustrate other examples of retail items disposed on a shelf structure in accordance with various aspects as described herein. FIG. 16D is a plan view of the frictionless store of FIG. 16A.

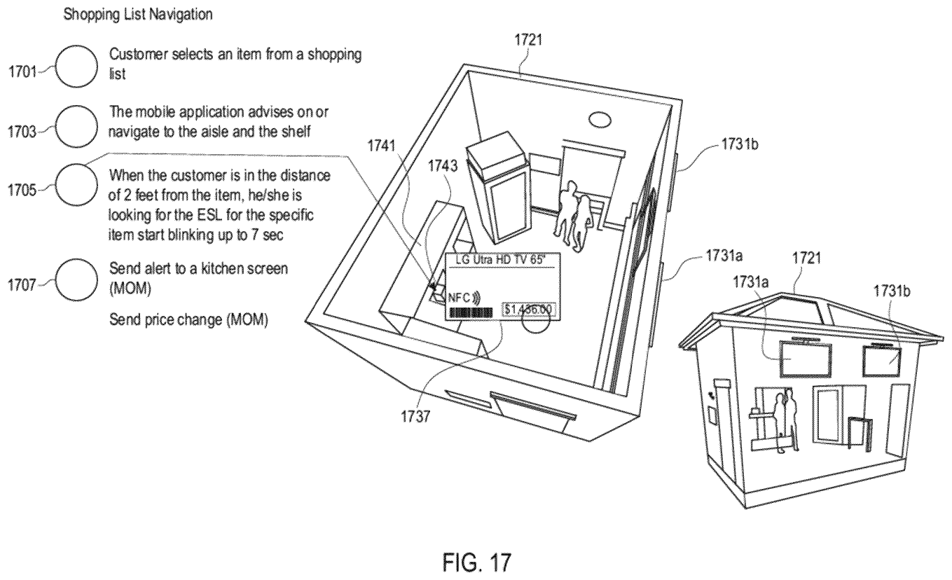

FIG. 17 illustrates another embodiment of a method 1700 of performing frictionless shopping in a frictionless store 1721 in accordance with various aspects as described herein. In FIG. 17, the method 1700 may start, for instance, at block 1701 where it can include receiving, by the frictionless system, from a wireless device of a subject over a network, an indication that includes a selected retail item from a shopping list of retail items of the subject. In response, the method 1700 can include determining a current position of the subject in the store 1721 based on or more images captured by a vision tracking system of the frictionless system. Further, the method 1700 can include obtaining a current location of the selected retail item on a certain shelf structure 1741 based on a planogram of the store 1721. In addition, the method 1700 can include obtaining, from the vision tracking system, one or more images that include display of the certain shelf structure 1741 and can include confirming that the selected retail item is disposed on the certain shelf structure 1741 based on those images. The method 1700 can include determining a navigation route through the store 1721 based on the current locations of the subject and the selected retail item and can include sending, by the frictionless system, to the wireless device of the subject, an indication that includes information associated with the navigation route. Also, the method 1700 can include determining that the subject is proximate (e.g., 1 foot, 2 feet, 3 feet, 4 feet, 5 feet, 10 feet) the selected retail item disposed on the shelf 1741 based on the current locations of the subject and the selected retail item. In response, the method 1700 can include sending, by the frictionless system, to a first display device of the set of display devices (e.g., ESLs) that is associated with and proximate the selected retail item, over the network, an indication that includes a request to enable an auditory (e.g., beep) or visual indication (e.g., blinking light) so that the selected retail item can be located on the certain shelf structure 1741 in the retail space based on the auditory or visual indication, as represented by block 1705. At block 1707, the method 1700 can include sending or outputting, by the frictionless system, for display on one or more display devices 1731a,b, an indication that includes information 1737 associated with a price change of the selected retail item such as based on markdown optimization management (MOM) algorithms configured to determine the timing or amount of price reductions or markdowns to increase revenue, clear inventory, maintain sales margins or the like based on sales velocity, inventory levels, seasonal demand, consumer purchasing patterns or the like.

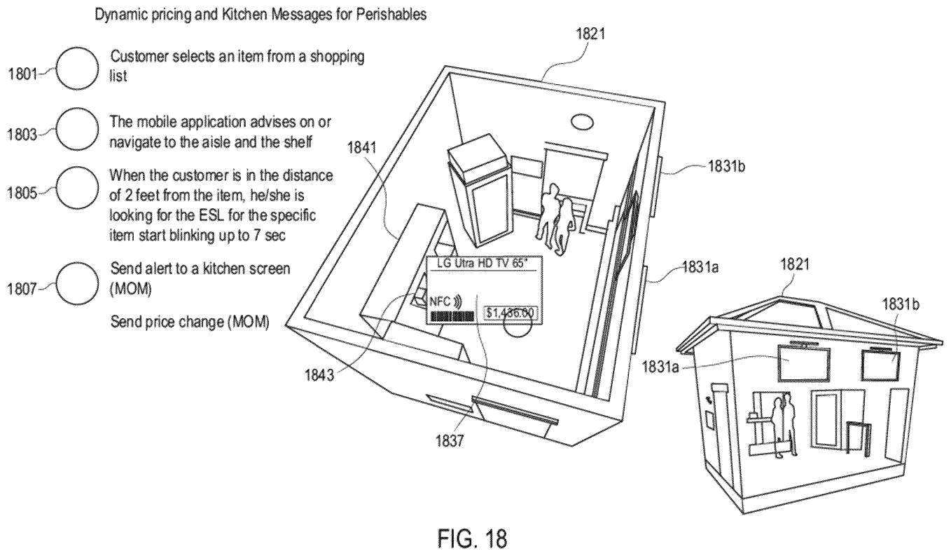

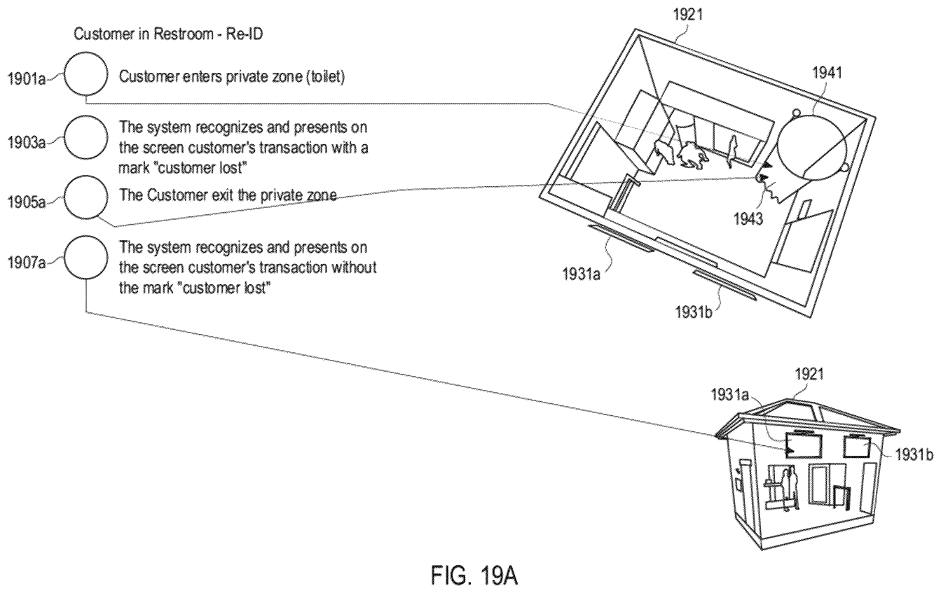

FIG. 18 illustrates another embodiment of a method 1800 of performing frictionless shopping in a frictionless store 1821 in accordance with various aspects as described herein. In FIG. 18, the method 1800 may start, for instance, at block 1801 where it can include receiving, by the frictionless system, from a wireless device of a subject over a network, an indication that includes a selected perishable item from a shopping list of retail items of the subject. In one example, a perishable item can refer to a good that has a limited shelf life due to its tendency to spoil, decay, or deteriorate over time. Further, a perishable item can require special handling, storage, or inventory management to enable that perishable item to remain sellable or safe for consumption. In response, the method 1800 can include determining a current position of the subject in the store 1821 based on or more images captured by a vision tracking system of the frictionless system. Further, the method 1800 can include obtaining a current location of the selected perishable item on a certain shelf structure 1841 based on a planogram of the store 1821. In addition, the method 1800 can include obtaining, from the vision tracking system, one or more images that include display of the certain shelf structure 1841 and confirming that the selected perishable item is disposed on the certain shelf structure 1841 based on those images. The method 1800 can include determining a navigation route through the store 1821 based on the current locations of the subject and the selected perishable item and can include sending, by the frictionless system, to the wireless device of the subject, an indication that includes information associated with the navigation route. Also, the method 1800 can include determining that the subject is proximate (e.g., 1 foot, 2 feet, 3 feet, 4 feet, 5 feet, 10 feet) the selected perishable item disposed on the shelf 1841 based on the current locations of the subject and the selected perishable item. In response, the method 1800 can include sending, by the frictionless system, to a first display device of the set of display devices (e.g., ESLs) that is associated with and proximate the selected perishable item, over the network, an indication that includes a request to enable an auditory or visual indication so that the selected perishable item can be located on the certain shelf structure 1841 in the retail space based on the auditory or visual indication, as represented by block 1805. At block 1807, the method 1800 can include sending or outputting, by the frictionless system, for display on one or more display devices 1831a,b, an indication that includes information 1837 associated with a price change of the selected perishable item such as based on markdown optimization management (MOM) algorithms configured to determine the timing and amount of price reductions or markdowns to increase revenue, clear inventory, maintain sales margins or the like based on sales velocity, inventory levels, seasonal demand, consumer purchasing patterns or the like.

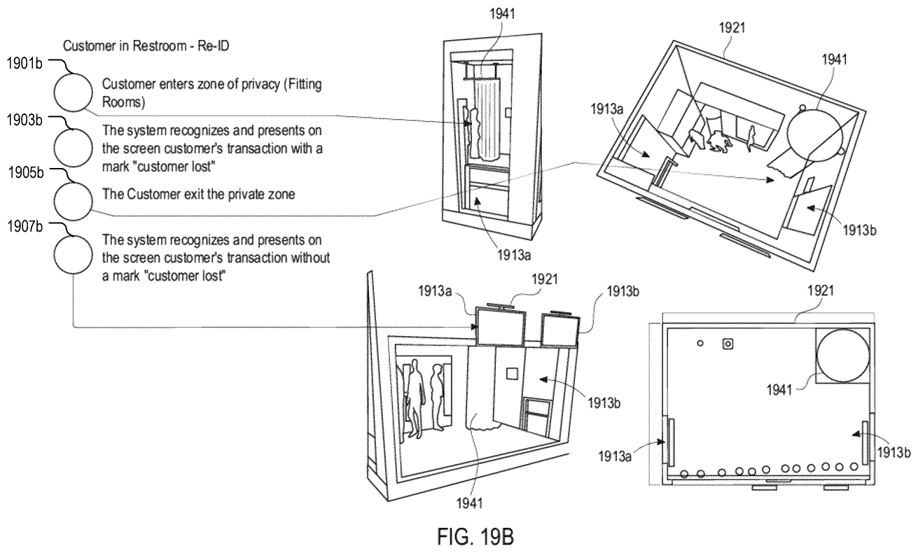

FIGS. 19A-19B illustrate other embodiments of a method 1900a,b of performing frictionless shopping in a frictionless store 1921 in accordance with various aspects as described herein. In FIG. 19A, the method 1900a may start, for instance, at block 1901a where it can include obtaining a current position of a subject or group member in the store 1921 based on one or more images captures by a vision tracking system of the frictionless system. Further, the method 1900a can include determining that the subject or group member is about or in a private area (e.g., toilet, fitting room, office) of the store 1921 based on the current position of the subject or group member. In response, the method 1900a can include rendering a virtual representation associated with the current transaction of the subject or group member with an indication (e.g., “customer lost”) associated with the subject or group member being undetected or no longer tracked by the frictionless system. At block 1903a, the method 1900a can include sending or outputting, by the frictionless system, for display by one or more display devices 1931a,b, an indication that includes that rendered virtual representation. At block 1905a, the method 1900 can include detecting that the subject or group member has exited the private area based on one or more images captured by the vision tracking system. In response, the method 1900a can include rendering a virtual representation associated with the current transaction of the subject or group member without the indication associated with the subject or group member being undetected or no longer tracked by the frictionless system. At block 1907a, the method 1900a can include sending or outputting, by the frictionless system, for display by the one or more display devices 1931a,b, an indication that includes that rendered virtual representation.

In FIG. 19B, the method 1900b may start, for instance, at block 1901b where it can include obtaining a current position of a subject or group member in the store 1921 based on one or more images captures by a vision tracking system of the frictionless system. Further, the method 1900b can include determining that the subject or group member is about or in a private area (e.g., toilet, fitting room, office) of the store 1921 based on the current position of the subject or group member. In response, the method 1900b can include rendering a virtual representation associated with the current transaction of the subject or group member with an indication (e.g., “customer lost”) associated with the subject or group member being undetected or no longer tracked by the frictionless system. At block 1903b, the method 1900b can include sending or outputting, by the frictionless system, for display by one or more display devices 1931a,b, an indication that includes that rendered virtual representation. At block 1905b, the method 1900 can include detecting that the subject or group member has exited the private area based on one or more images captured by the vision tracking system. In response, the method 1900b can include rendering a virtual representation associated with the current transaction of the subject or group member without the indication associated with the subject or group member being undetected or no longer tracked by the frictionless system. At block 1907b, the method 1900b can include sending or outputting, by the frictionless system, for display by one or more display devices 1931a,b, an indication that includes that rendered virtual representation.

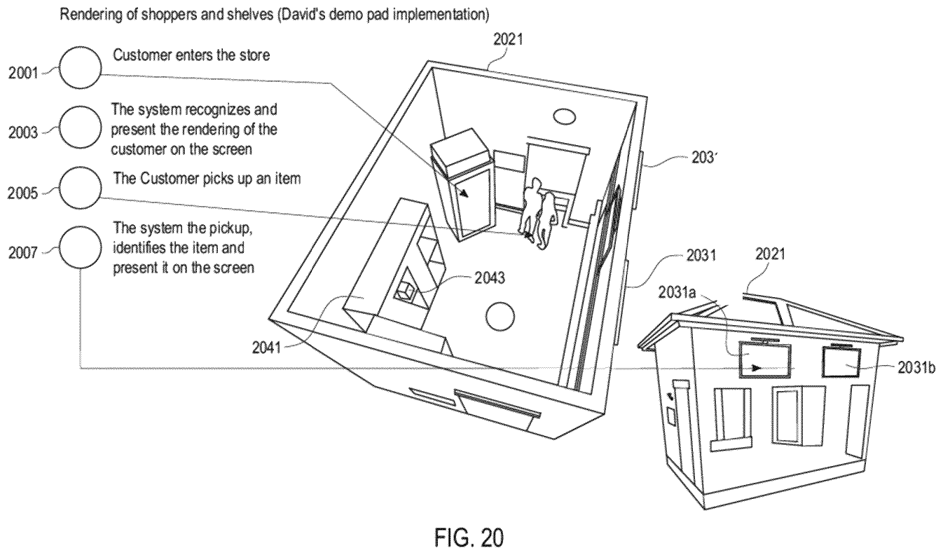

FIG. 20 illustrates another embodiment of a method 2000 of performing frictionless shopping in a frictionless store 2021 in accordance with various aspects as described herein. In FIG. 20, the method 2000 may start, for instance, at block 2001 where it can include tracking, by a frictionless system via its vision tracking system based on one or more images associated with the subject or group member as that subject or group member enters the store 2021. Further, the method 2000a can include determining that the subject or group member has entered the store 2021. At block 2003, the method 2000 can include recognizing the subject or group member based on the one or more images associated with the subject or group member. The method 2000 can include rendering a visual representation (e.g., facial image, POPid, other identifier) associated with the recognized subject or group member. The method 2000a can include sending or outputting, by the frictionless system, for display on one more display devices 2031a-b disposed in the frictionless store 2021, an indication that includes the rendered visual representation of the subject or group member. Further, the method 2000 can include tracking activities of the subject or group member as that subject or group member traverses the store 2021, including movement tracking, shelf structure interaction, retail item interaction, shopping basket interaction, or the like. At block 2005, the method 2000 can include determining that a certain retail item has been obtained by the subject or group member and in response, can include rendering a visual representation of the obtained retail item. At block 2007, the method 2000 can include sending or outputting, by the frictionless system, for display on the one more display devices 2031a-b, an indication that includes the rendered visual representation of the obtained retail item. In one example, the visual representation of the obtained retail item is rendered proximate the visual representation of the subject or group member that obtained that retail item. As such, the one more display devices 2031a-b display those retail items obtained by the subject or group member so that the subject or group member can view on the one or more display devices 2031a-b those retail items obtained by the subject or group member.

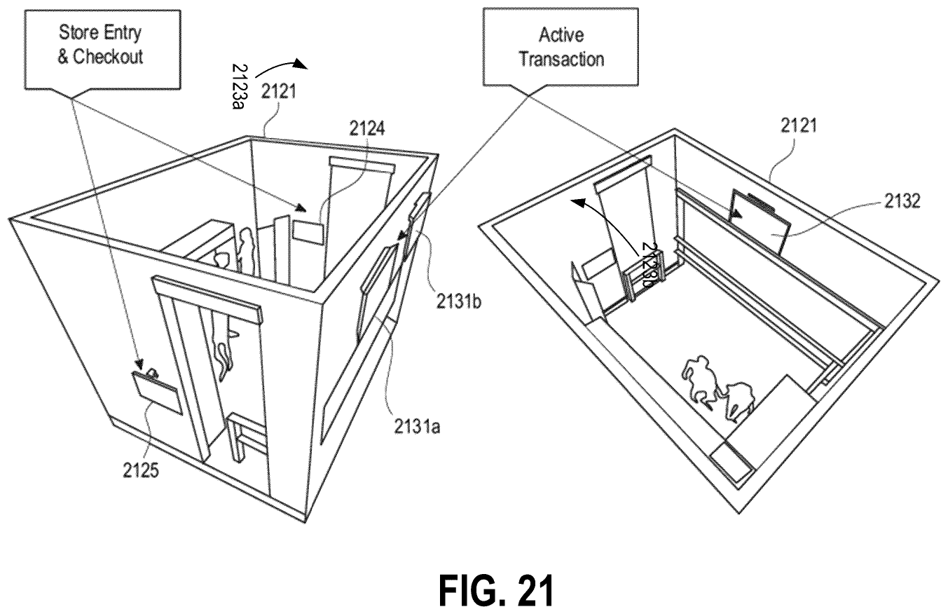

FIG. 21 illustrates another embodiment of a frictionless store 2121 in accordance with various aspects as described herein. The frictionless store 2121 can include entrance and exit portals 2123a,b, a checkout terminal device 2124 (e.g., touchscreen) operable to enable a checkout transaction or exit the frictionless store 2121 through the exit portal 2123b, an entry display device 2125 operable to enable a subject to enter the frictionless store 2121 through the entrance portal 2123a, one or more display devices 2131a,b operable to display information associated with a subject and that subject's active transaction in the frictionless store 2121, or the like.

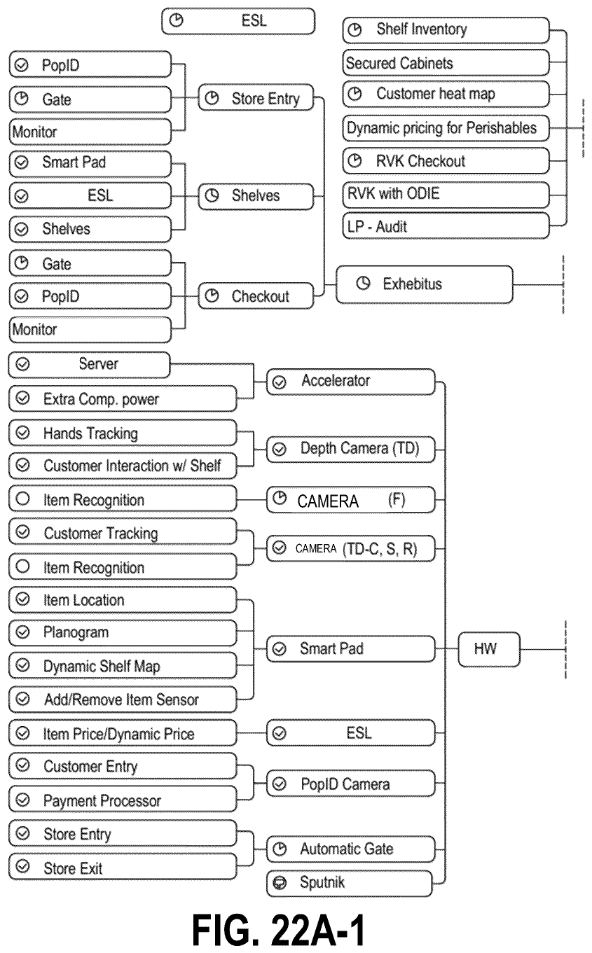

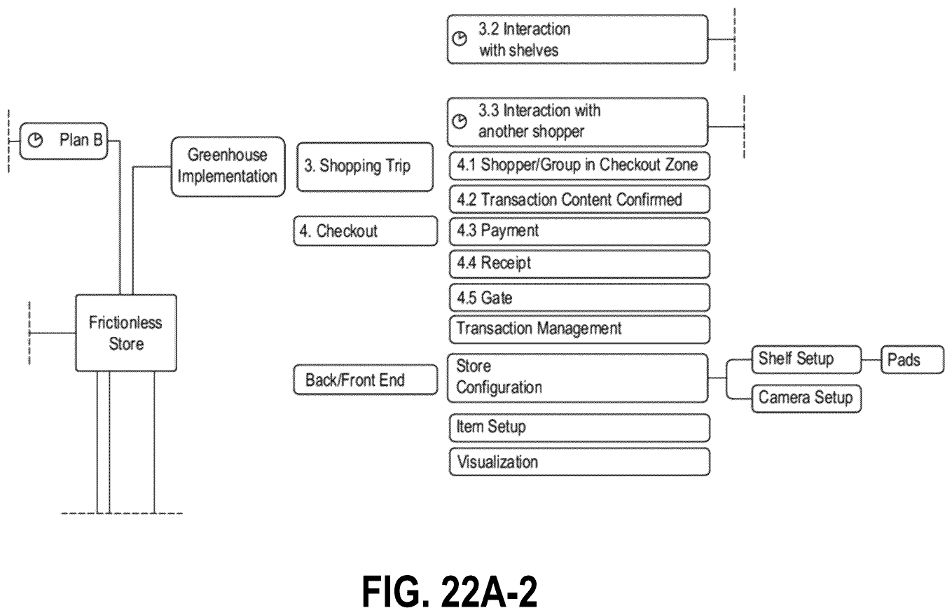

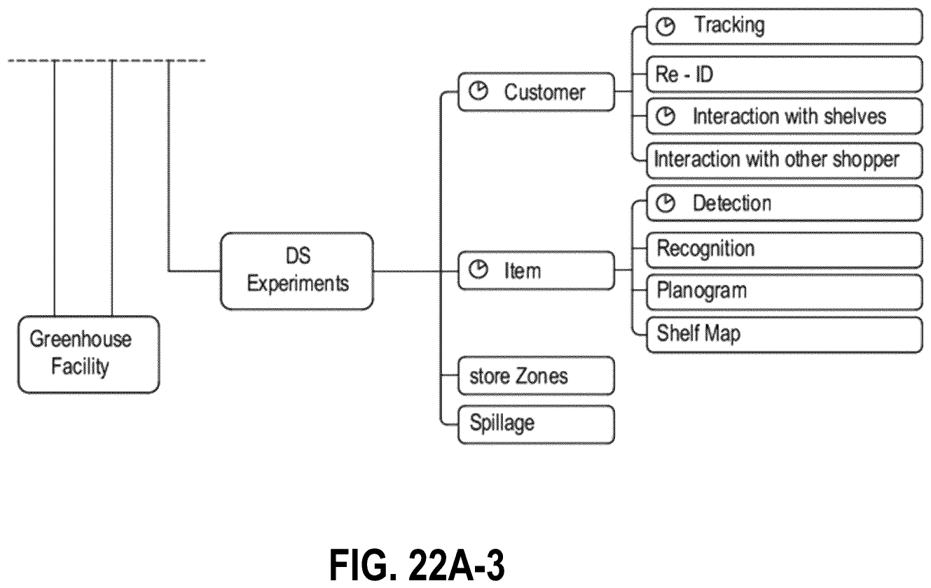

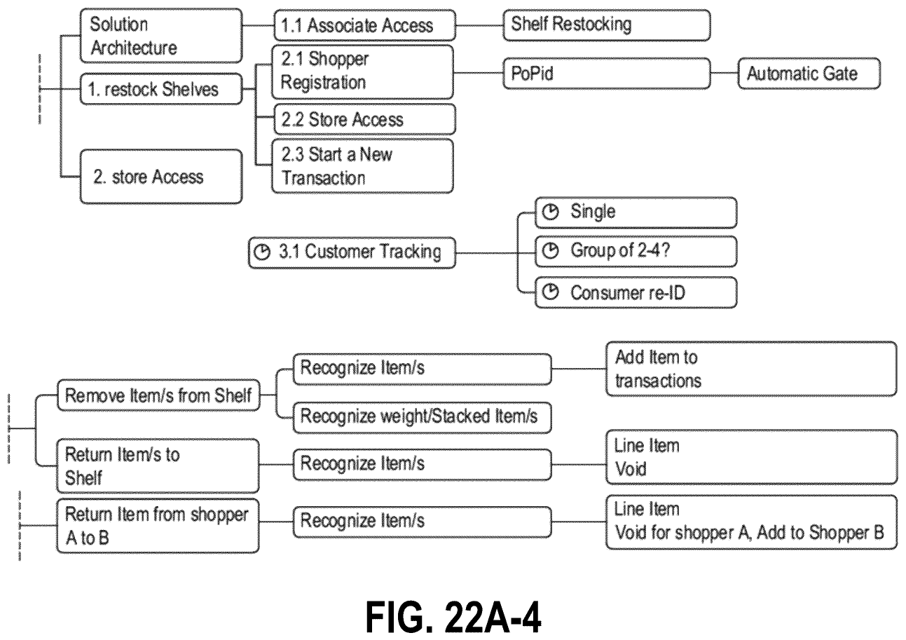

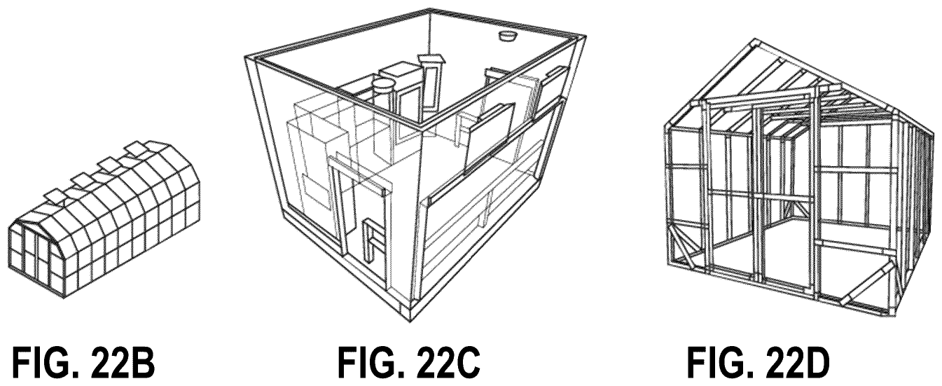

FIGS. 22A-1 to 22A-4 illustrate exemplary component diagrams of a frictionless system operable to enable frictionless shopping in a frictionless store in accordance with various aspects as described herein. Each component diagram illustrates a relationship between components (e.g., objects) of the frictionless system. FIGS. 22B-22C illustrate other embodiments of a frictionless store in accordance with various aspects as described herein.

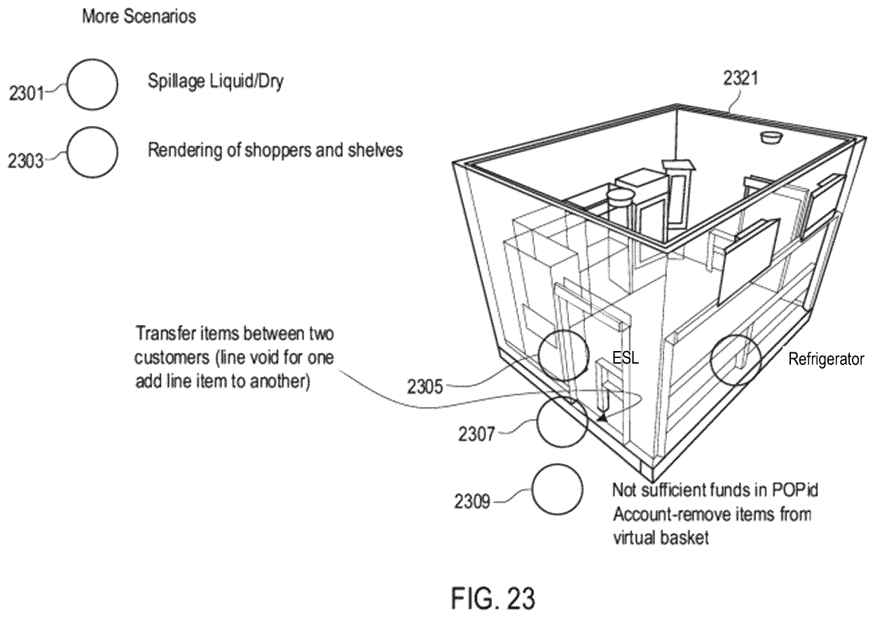

FIG. 23 illustrates another embodiment of a method 2300 of performing frictionless shopping in a frictionless store 2321 in accordance with various aspects as described herein. In FIG. 23, the method 2300 may start, for instance, at block 2301 where it can include detecting, by a frictionless system of the store 2321, a spillage (e.g., liquid item, dry item, refrigerator leak) in the store 2321 based on one or more images captured by a vision tracking system of the frictionless system. In response, the method 2300 can send, by the frictionless system, to a network node over a network, an indication that includes a request associated with cleaning or removing the spillage. Further, the method 2300 can send, by the frictionless system, to each wireless device of subjects in the store 2321, an indication that includes information associated with the spillage (e.g., warning, location). In addition, the method 2300 can send, by the frictionless system, for display by one or more of display devices in the store 2321, an indication that includes information associated with the spillage (e.g., warning, location). At block 2303, the method 2300 can include rendering a visual representation that includes the subjects and the position of those subjects in the store 2321 and the position of the shelf structures in the store 2321. Further, the method 2300 can send or output, by the frictionless system, for display by the one more display devices in the store 2321, an indication that includes the rendered visual representation. At block 2305, the method 2300 can include managing the set of display devices (e.g., ESLs) with each display device being proximate a corresponding retail item of a set of retail items of the store 2321. At block 2307, the method 2300 can include transferring a retail item obtained by a group member to an authenticated subject of that group. At block 2309, the method 2300 can include determining that the payment information associated with a secure digital identifier (e.g., POPid) of an authenticated subject does not have sufficient funds to complete payment of a transaction. In response, the method 2300 can include removing a retail item from the virtual shopping cart of that subject.

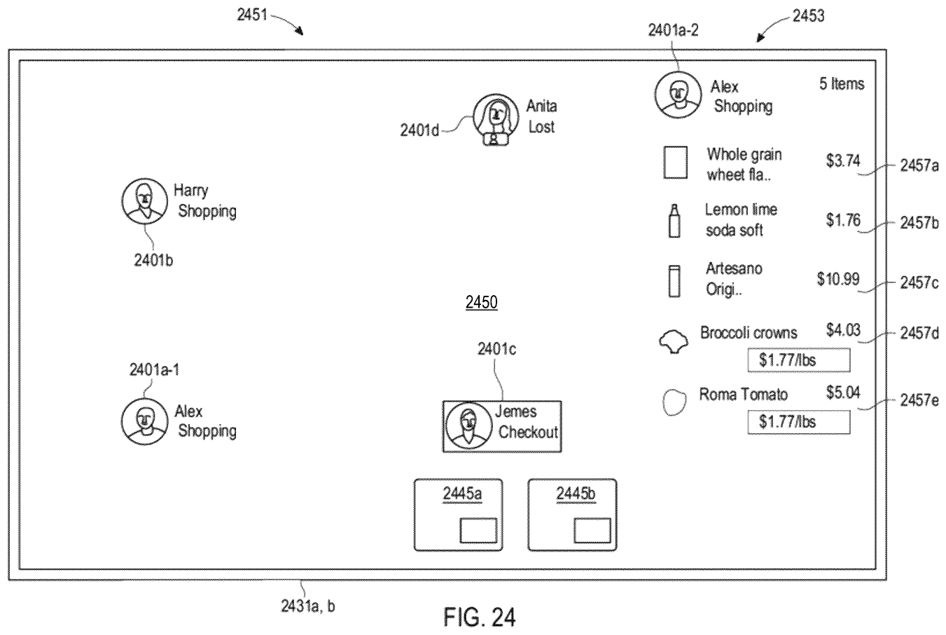

FIG. 24 illustrates an exemplary virtual representation 2450 of a frictionless store in accordance with various aspects as described herein. In FIG. 24, the virtual representation 2450 can be displayed on one or more display devices 2431a,b in the store. The virtual representation can include a first region 2451 associated with the layout of the store 2445a, 2445b and the relative positions of subjects 240a-1, 204b-d in the store and a second region 2453 associated with a virtual shopping cart of one or more subjects 2401a-2 in the store. The virtual shopping cart can include a list of obtained retail items 2457a-e with each obtained retail item being represented by an image, description, quantity, price or the like of that item.

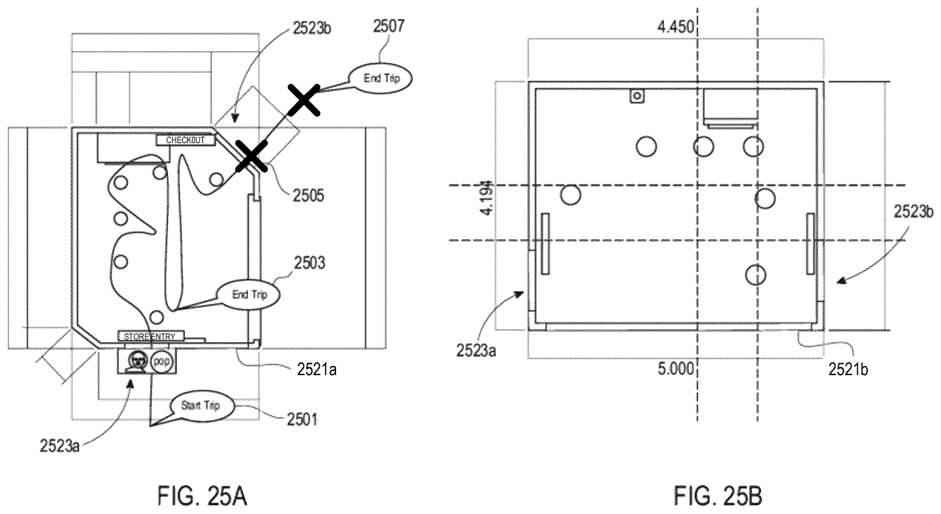

FIG. 25A is a plan view of another embodiment of a frictionless store 2521a in accordance with various aspects as described herein. In FIG. 25A, a subject may start a visit to the frictionless store 2521a at point 2501. At or about point 2521a, the subject can be authenticated to enable entry to the frictionless store 2521a through the entrance portal 2523a. The frictionless system via the vision tracking system can track the subject as that subject traverses about the frictionless store 2521a. The subject can end the visit by exiting the frictionless store 2521a through the exit portal 2523b, as represented by point 2507. FIG. 25B is a plan view of another embodiment of a frictionless store 1521b in accordance with various aspects as described herein. In FIG. 25B, the store 1521b can include entrance and exit portals 2523a,b.

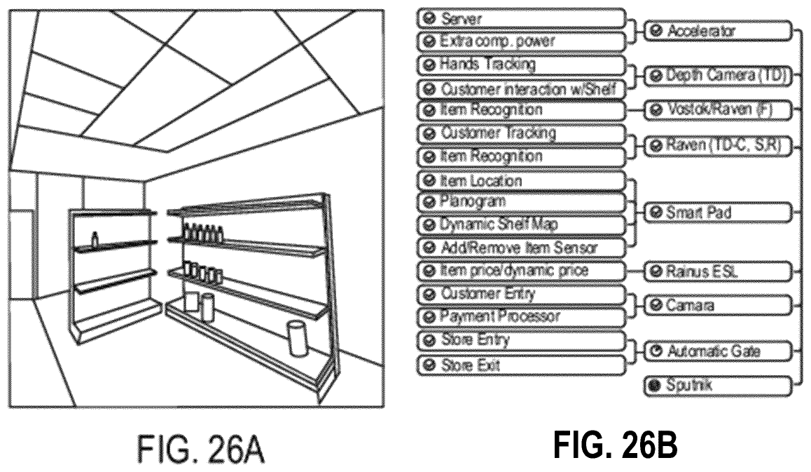

FIG. 26A illustrates another embodiments of a frictionless store in accordance with various aspects as described herein. FIG. 26B illustrates another embodiment of components of a frictionless system of a frictionless store in accordance with various aspects as described herein.

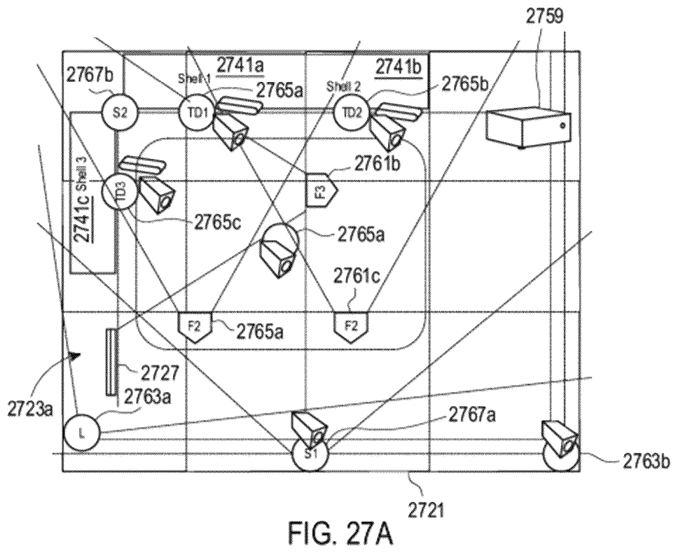

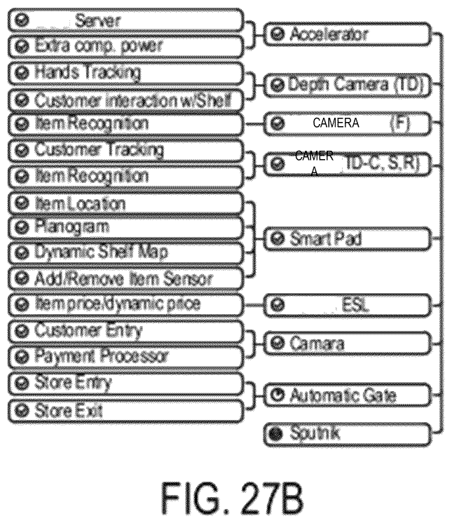

FIG. 27A illustrates another embodiment of a frictionless store 2721 in accordance with various aspects as described herein. In FIG. 27A, the store 2721 can include shelf structures 2741a-c, optical sensor devices 2765a-c (e.g., camera) configured with field of view associated with a corresponding shelf structure 2741a-c such as a top-down field of view, an optical sensor device 2741d (e.g., camera) configured with a field of view associated with a central area of the store 2721, optical sensor services 2761a-c (e.g., camera) configured with a field of view towards the front of a corresponding shelf structure 2741a-c, optical sensor devices 2767a-b, 2763a-b (e.g., camera) configured for tracking subjects in the store 2721, a vision tracking system 2759, an entrance portal 2723a, an entrance gate device having an entrance gate 2727, an exit portal, an exit gate device having an exit gate, or the like. In FIG. 27A, the acronym “TD” means top-down camera, the acronym “TD-C” means a top-down central camera, the acronym “F” means a front-view camera, and the acronyms “L” and “R” means cameras for general tracking of subjects. Further, the dotted lines from each optical sensor device 2765a-c, 2763a-b represent a field of view for that device 2765a-c, 2763a-b. FIG. 27B illustrates another exemplary component diagram of a frictionless system operable to enable frictionless shopping in the frictionless store of FIG. 27A.

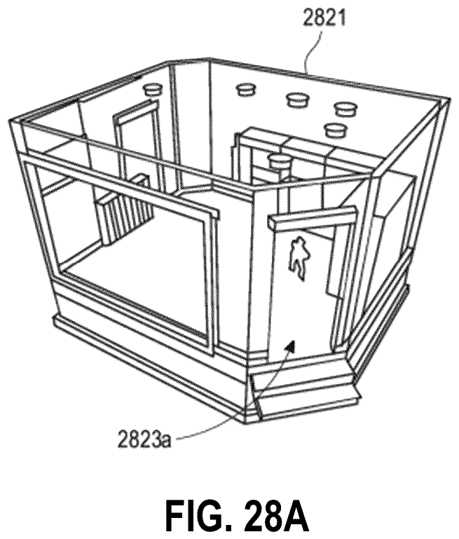

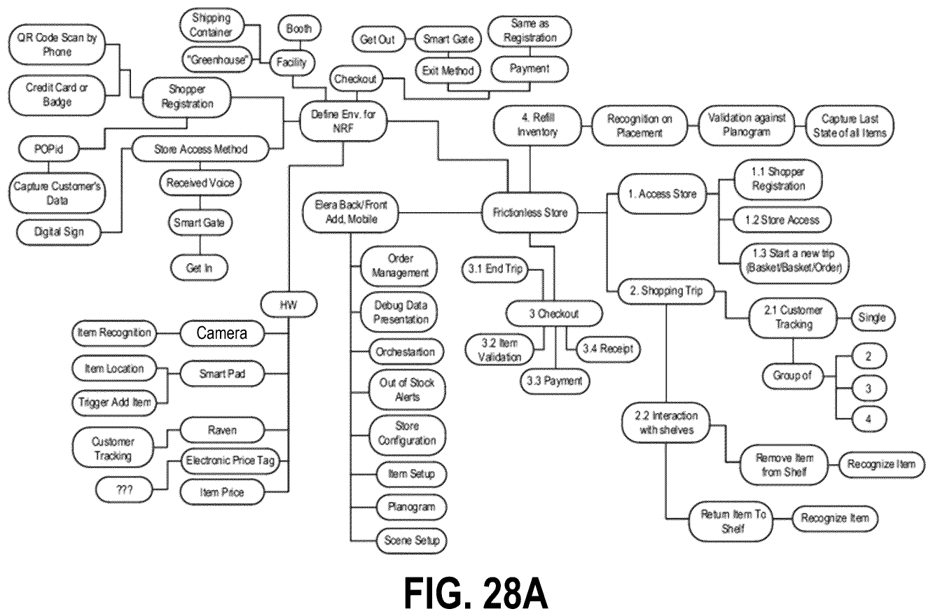

FIG. 28A illustrates another embodiments of a frictionless store 2821 in accordance with various aspects as described herein. In FIG. 8A, the store 2821 can include an entry portal 2823a. FIG. 28B illustrates another exemplary component diagram of a frictionless system operable to enable frictionless shopping in the frictionless store 2821 of FIG. 28A.

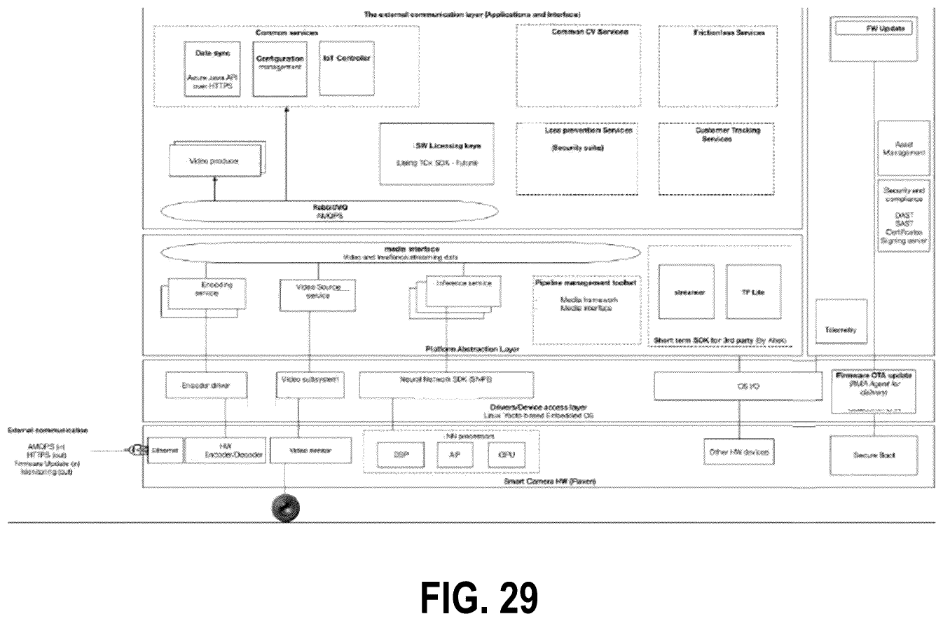

FIG. 29 illustrates one embodiment of a communication layer of a frictionless system 2900 of a frictionless store in accordance with various aspects as described herein. In FIG. 29, the system 2900 can enable distributed sharing of large buffers (e.g., image streams) across different components such as components that form a media framework. Further, the system 2900 can include a media interface (e.g., interprocess API) that can enable cross-lingual video (e.g., Java/C++/Python video) and machine learning data sets development and can enable platform access layer (PAL) that can include abstract media sharing from the application of a specific hardware architecture.

Additional embodiments will now be described. At least some of these embodiments may be described as applicable in certain contexts for illustrative purposes, but the embodiments are similarly applicable in other contexts not explicitly described.

In one exemplary embodiment, a method is performed by a network node operationally coupled over a network to an optical sensor device having a field of view towards a shelf structure in a first region with the shelf structure having a set of stocked items and operable to capture an image that includes the shelf structure and to a set of display devices disposed on the shelf structure with each display device being specific to and proximate a certain stocked item of the shelf structure and operable to display stocked item information of the certain stocked item, with the shelf structure having shelves, with each shelf having a portion of the set of stocked items with any of the same stocked items being transversely arranged on that shelf. The method includes sending, to a first display device of the set of display devices that is specific to and proximate a stocked item electronically requested by a shopper, over the network, an indication that includes a request to enable an auditory or visual indication so that the shopper can identify the certain stocked item located on the shelf structure based on the auditory or visual indication, with each display device being operable to enable an auditory or visual indication.

In another exemplary embodiment, the method can further include receiving, by the network node, from a wireless device associated with the shopper, over the network, an indication that includes a request for navigation information from a current location of the wireless device or the shopper in the first region to a location of the certain stocked item on the shelf structure.

In another exemplary embodiment, the method can further include obtaining a current location of the shopper or the wireless device in the first region based on image data received from the optical sensor device or current location information received from the wireless device.

In another exemplary embodiment, the method can further include obtaining a location of the certain stocked item on the shelf structure in the first region based on a planogram of the first region that includes a location of each shelf structure in the first region and a location of each stocked item on the shelf structures.

In another exemplary embodiment, the method can further include verifying that the certain stocked item is at the location based on image data received from the optical sensor device.

In another exemplary embodiment, the method can further include determining navigation information from a current location of the wireless device or the shopper in the first region to a location of the certain stocked item on the shelf structure based on a first region planogram and the current location of the shopper or the wireless device.

In another exemplary embodiment, the method can further include sending, by the network node, to the wireless device over the network, an indication that includes navigation information from a current location of the wireless device or the shopper in the first region to a location of the certain stocked item on the shelf structure.

In another exemplary embodiment, the method can further include determining that the shopper or the wireless device is approaching towards or is proximate a location of the certain stocked item on the shelf structure based on image data received from the optical sensor device or current location information received from the wireless device of the shopper.

In another exemplary embodiment, the method can further include determining that the shopper has removed the certain stocked item from the shelf structure and sending, by the network node, to the first display device over the network, an indication that includes a request to disable the auditory or visual indication.

In another exemplary embodiment, the method can further include determining that the shopper is proximate the location of the certain stocked item on the shelf structure for at least a certain time period and sending, by the network node, to the first display device over the network, an indication that includes a request to disable the auditory or visual indication.

In one exemplary embodiment, a network node device is operationally coupled over a network to an optical sensor device having a field of view towards a shelf structure in a first region, with the shelf structure having a set of stocked items and operable to capture an image that includes the shelf structure and to a set of display devices disposed on the shelf structure with each display device being specific to and proximate a certain stocked item of the shelf structure and operable to display stocked item information of the certain stocked item, with the shelf structure having shelves with each shelf having a portion of the set of stocked items with any of the same stocked items being transversely arranged on that shelf. The network node device further includes processing circuitry and a memory, the memory containing instructions executable by the processing circuitry whereby the processing circuitry is configured to send, to a first display device of the set of display devices that is specific to and proximate a stocked item electronically requested by a shopper, over the network, an indication that includes a request to enable an auditory or visual indication so that the shopper can identify the certain stocked item located on the shelf structure based on the auditory or visual indication, with each display device being operable to enable an auditory or visual indication.

In another exemplary embodiment, the memory includes further instructions executable by the processing circuitry whereby the processing circuitry is configured to receive, over the network from a wireless device associated with the shopper, an indication that includes a request for navigation information from a current location of the wireless device or the shopper in the first region to a location of the certain stocked item on the shelf structure.

In another exemplary embodiment, the memory includes further instructions executable by the processing circuitry whereby the processing circuitry is configured to obtain a current location of the shopper or the wireless device in the first region based on image data received from the optical sensor device or current location information received from the wireless device.

In another exemplary embodiment, the memory includes further instructions executable by the processing circuitry whereby the processing circuitry is configured to obtain a location of the certain stocked item on the shelf structure in the first region based on a planogram of the first region that includes a location of each shelf structure in the first region and a location of each stocked item on the shelf structures.

In another exemplary embodiment, the memory includes further instructions executable by the processing circuitry whereby the processing circuitry is configured to verify that the certain stocked item is at the location based on image data received from the optical sensor device.

In another exemplary embodiment, the memory includes further instructions executable by the processing circuitry whereby the processing circuitry is configured to determine navigation information from a current location of the wireless device or the shopper in the first region to a location of the certain stocked item on the shelf structure based on a first region planogram and the current location of the shopper or the wireless device.

In another exemplary embodiment, the memory includes further instructions executable by the processing circuitry whereby the processing circuitry is configured to send, to the wireless device over the network, an indication that includes navigation information from a current location of the wireless device or the shopper in the first region to a location of the certain stocked item on the shelf structure.

In another exemplary embodiment, the memory includes further instructions executable by the processing circuitry whereby the processing circuitry is configured to determine that the shopper or the wireless device is approaching towards or is proximate a location of the certain stocked item on the shelf structure based on image data received from the optical sensor device or current location information received from the wireless device of the shopper.

In another exemplary embodiment, the memory includes further instructions executable by the processing circuitry whereby the processing circuitry is configured to determine that the shopper has removed the certain stocked item from the shelf structure and send, to the first display device over the network, an indication that includes a request to disable the auditory or visual indication.

In another exemplary embodiment, the memory includes further instructions executable by the processing circuitry whereby the processing circuitry is configured to determine that the shopper is proximate the location of the certain stocked item on the shelf structure for at least a certain time period and send, to the first display device over the network, an indication that includes a request to disable the auditory or visual indication.

In one exemplary embodiment, a method is performed by a first network node operationally coupled over a network to a fourth network node having a presence sensitive display device and a first optical sensor device with both devices being positioned proximate an entrance at a perimeter of a first region, with the first network node being operationally coupled over the network to a second optical sensor device having a field of view towards a shelf structure in the first region with the shelf structure having a set of stocked items and operable to capture an image that includes the shelf structure and a set of display devices disposed on the shelf structure with each display device being specific to and proximate a certain stocked item of the shelf structure and operable to display stocked item information of the certain stocked item, with the shelf structure having shelves with each shelf having a portion of the set of stocked items with any of the same stocked items being transversely arranged on that shelf. The method includes sending, to each display device over the network, an indication that includes a request to display information associated with restocking the corresponding stocked item responsive to authenticating a person that requests authorized access to the first region via the presence sensitive display as one of a set of authorized associates that have access to the first region.

In another exemplary embodiment, the method can further include authenticating the person that requests authorized access as one of the set of authorized associates that have access to the first region.

In another exemplary embodiment, the step of authenticating can include determining to authenticate the person.

In another exemplary embodiment, the step of determining to authenticate can include outputting, by processing circuitry of the first network node, for display by the presence sensitive display, an indication that includes a visual representation associated with a request to authenticate the person as one of the set of authorized associates to enable access to the first region and receiving, by the processing circuitry of the first network node, from the presence sensitive display, an indication of a touch gesture detected at or about the visual representation associated with the authentication request. Further, the step of determining to authenticate the person can be responsive to determining that the touch gesture corresponds to the visual representation.

In another exemplary embodiment, the step of authenticating can include determining that the person displayed in an image captured by the first optical sensor corresponds to one of the set of authorized associates having access to the first region.

In another exemplary embodiment, the method can further include sending, by the processing circuitry of the first network node, to the first optical sensor device having a viewing angle towards a region associated with a person operating the presence sensitive display, an indication that includes a request to capture an image of the person to be authenticated and receiving, by the processing circuitry of the first network node, from the first optical sensor device, the captured image that includes the person to be authenticated.

In another exemplary embodiment, the method can further include determining to enable access to the first region by the authenticated person.

In another exemplary embodiment, the method can further include sending, by the first network node, to an entrance coupling device proximate the entrance and operable to lock or unlock the entrance to the first region, an indication to unlock the entrance to the first region.

In another exemplary embodiment, the method can further include determining to configure the set of display devices disposed on the shelf structure to indicate information associated with restocking the set of restocked items; and

In another exemplary embodiment, the method can further include obtaining stock information of a first stocked item of the set of stocked items and sending, by the first network node, for display by one of the set of display devices that corresponds to the first stocked item, a visual representation associated with the stock information.

In one exemplary embodiment, a first network node device is operationally coupled over a network to a fourth network node having a presence sensitive display device and a first optical sensor device with both devices being positioned proximate an entrance at a perimeter of a first region, with the first network node being operationally coupled over the network to a second optical sensor device having a field of view towards a shelf structure in the first region with the shelf structure having a set of stocked items and operable to capture an image that includes the shelf structure and a set of display devices disposed on the shelf structure with each display device being specific to and proximate a certain stocked item of the shelf structure and operable to display stocked item information of the certain stocked item, with the shelf structure having shelves with each shelf having a portion of the set of stocked items with any of the same stocked items being transversely arranged on that shelf. Further, the first network node includes processing circuitry and a memory, the memory containing instructions executable by the processing circuitry whereby the processing circuitry is configured to send, to each display device over the network, an indication that includes a request to display information associated with restocking the corresponding stocked item responsive to authenticating a person that requests authorized access to the first region via the presence sensitive display as one of a set of authorized associates that have access to the first region.

In another exemplary embodiment, the memory can include further instructions executable by the processing circuitry whereby the processing circuitry is configured to authenticate the person that requests authorized access as one of the set of authorized associates that have access to the first region.

In another exemplary embodiment, the memory can include further instructions executable by the processing circuitry whereby the processing circuitry is configured to determine to authenticate the person.

In another exemplary embodiment, the memory can include further instructions executable by the processing circuitry whereby the processing circuitry is configured to output, by processing circuitry of the device, for display by the presence sensitive display, an indication that includes a visual representation associated with a request to authenticate the person as one of the set of authorized associates to enable access to the first region, receive, by the processing circuitry, from the presence sensitive display, an indication of a touch gesture detected at or about the visual representation associated with the authentication request, and determine to authenticate the person responsive to determining that the touch gesture corresponds to the visual representation.

In another exemplary embodiment, the memory can include further instructions executable by the processing circuitry whereby the processing circuitry is configured to determine that the person displayed in an image captured by the first optical sensor corresponds to one of the set of authorized associates having access to the first region.

In another exemplary embodiment, the memory can include further instructions executable by the processing circuitry whereby the processing circuitry is configured to sending, by the processing circuitry of the first network node, to the first optical sensor device having a viewing angle towards a region associated with a person operating the presence sensitive display, an indication that includes a request to capture an image of the person to be authenticated and receiving, by the processing circuitry of the first network node, from the first optical sensor device, the captured image that includes the person to be authenticated.

In another exemplary embodiment, the memory can include further instructions executable by the processing circuitry whereby the processing circuitry is configured to determine to enable access to the first region by the authenticated person.

In another exemplary embodiment, the memory can include further instructions executable by the processing circuitry whereby the processing circuitry is configured to send, to an entrance coupling device proximate the entrance and operable to lock or unlock the entrance to the first region, an indication to unlock the entrance to the first region.

In another exemplary embodiment, the memory can include further instructions executable by the processing circuitry whereby the processing circuitry is configured to determine to configure the set of display devices disposed on the shelf structure to indicate information associated with restocking the set of restocked items.

In another exemplary embodiment, the memory can include further instructions executable by the processing circuitry whereby the processing circuitry is configured to obtain stock information of a first stocked item of the set of stocked items and send, by the first network node, for display by one of the set of display devices that corresponds to the first stocked item, a visual representation associated with the stock information.

In one exemplary embodiment, a method is performed by a first network node operationally coupled over a network to a fourth network node having a presence sensitive display device and a first optical sensor device with both devices being positioned proximate an entrance at a perimeter of a first region, with the first network node being operationally coupled over the network to a second optical sensor device having a field of view towards a shelf structure in the first region with the shelf structure having a set of stocked items and operable to capture an image that includes the shelf structure and a set of display devices disposed on the shelf structure with each display device being specific to and proximate a certain stocked item of the shelf structure and operable to display stocked item information of the certain stocked item, with the shelf structure having shelves with each shelf having a portion of the set of stocked items with any of the same stocked items being transversely arranged on that shelf. The method includes associating a person that enters the entrance within a certain time period after authenticating a person that requests customer access to the first region with the authenticated person so that the first network node is enabled to associate stocked items purchased by the associated person with the authenticated person.

In one exemplary embodiment, a first network node device is operationally coupled over a network to a fourth network node having a presence sensitive display device and a first optical sensor device with both devices being positioned proximate an entrance at a perimeter of a first region, with the first network node being operationally coupled over the network to a second optical sensor device having a field of view towards a shelf structure in the first region with the shelf structure having a set of stocked items and operable to capture an image that includes the shelf structure and a set of display devices disposed on the shelf structure with each display device being specific to and proximate a certain stocked item of the shelf structure and operable to display stocked item information of the certain stocked item, with the shelf structure having shelves with each shelf having a portion of the set of stocked items with any of the same stocked items being transversely arranged on that shelf. The first network node device includes processing circuitry and a memory, the memory containing instructions executable by the processing circuitry whereby the processing circuitry is configured to associate a person that enters the entrance within a certain time period after authenticating a person that requests customer access to the first region with the authenticated person so that the first network node is enabled to associate stocked items purchased by the associated person with the authenticated person.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by a network node device operationally coupled over a network to a set of optical sensor devices positioned throughout a retail space having a set of shelf structures, with each shelf structure having a portion of a set of stocked items with any of the same stocked items being transversely arranged on that shelf structure, each optical sensor device having an optical sensor with a field of view towards at least one of the set of shelf structures in the retail space, each optical sensor device being operable to capture an image that includes those retail items of the set of retail items that are disposed on the corresponding shelf structure, each shelf structure having a set of display devices with each display device being associated with and proximate a certain stocked item of the set of stocked items that is disposed on that shelf structure and operable to display a visual indication or generate an auditory indication,
sending, to a first display device of the set of display devices that is associated with and proximate a certain stocked item of the set of stocked items that is electronically requested, over the network, an indication that includes a request to enable an auditory or visual indication so that the certain stocked item can be located on a corresponding shelf structure of the set of shelf structures in the retail space based on the auditory or visual indication.

2. The method of claim 1, further comprising:
receiving, by the network node device, from a wireless device associated with the subject, over the network, an indication that includes a request for navigation information from a current location of the subject or the wireless device in the retail space to a location of the certain stocked item on the corresponding shelf structure.

3. The method of claim 1, further comprising:
obtaining a current location of the subject or the wireless device in the retail space based on image data received from the optical sensor device or current location information received from the wireless device.

4. The method of claim 1, further comprising:
obtaining a location of the certain stocked item on the corresponding shelf structure based on a planogram of the retail space that includes locations of the set of shelf structures in the retail space and a location of each stocked item on the set of shelf structures.

5. The method of claim 4, further comprising:
verifying that the certain stocked item is at the location on the corresponding shelf structure based on image data received from at least one of the set of optical sensor devices that has the field of view towards the corresponding shelf structure.

6. The method of claim 1, further comprising:
determining navigation information from the current location of the wireless device or the subject in the retail space to a location of the certain stocked item on the corresponding shelf structure based on a retail space planogram and the current location of the subject or the wireless device.

7. The method of claim 1, further comprising:
sending, by the network node device, to the wireless device over the network, an indication that includes navigation information from a current location of the wireless device or the subject in the retail space to a location of the certain stocked item on the corresponding shelf structure.

8. The method of claim 1, further comprising:
determining that the subject or the wireless device is approaching towards or is proximate a location of the certain stocked item on the corresponding shelf structure based on image data received from the optical sensor device or current location information received from the wireless device of the subject.

9. The method of claim 1, further comprising:
determining that the certain stocked item has been removed from the shelf structure while the subject or the wireless device is proximate the location of that certain stocked item; and
sending, by the network node device, to the first display device over the network, an indication that includes a request to disable the auditory or visual indication.

10. The method of claim 1, further comprising:
determining that the subject or the wireless device is proximate the location of the certain stocked item on the corresponding shelf structure for at least a predetermined time period; and
sending, by the network node device, to the first display device over the network, an indication that includes a request to disable the auditory or visual indication.

11. A network node device, comprising:
with the network node device being operationally coupled over a network to a set of optical sensor devices positioned throughout a retail space having a set of shelf structures, with each shelf structure having a portion of a set of stocked items with any of the same stocked items being transversely arranged on that shelf structure, each optical sensor device having an optical sensor with a field of view towards at least one of the set of shelf structures in the retail space, each optical sensor device having an optical sensor operable to capture an image that includes the corresponding shelf structure, each shelf structure having a set of display devices with each display device being associated with and proximate a certain stocked item of the set of stocked items that is disposed on that shelf structure and operable to display a visual indication or generate an auditory indication; and
wherein the network node device further includes processing circuitry and a memory, the memory containing instructions executable by the processing circuitry whereby the processing circuitry is configured to:
send, to a first display device of the set of display devices that is associated with and proximate a certain stocked item of the set of stocked items that is electronically requested, over the network, an indication that includes a request to enable an auditory or visual indication so that the certain stocked item can be located on a corresponding shelf structure of the set of shelf structures in the retail space based on the auditory or visual indication.

12. The device of claim 11, wherein the memory includes further instructions executable by the processing circuitry whereby the processing circuitry is configured to:
receive, from a wireless device associated with the subject, over the network, an indication that includes a request for navigation information from a current location of the subject or the wireless device in the retail space to a location of the certain stocked item on the corresponding shelf structure.

13. The device of claim 11, wherein the memory includes further instructions executable by the processing circuitry whereby the processing circuitry is configured to:
obtain a current location of the subject or the wireless device in the retail space based on image data received from the optical sensor device or current location information received from the wireless device.

14. The device of claim 11, wherein the memory includes further instructions executable by the processing circuitry whereby the processing circuitry is configured to:
obtain a location of the certain stocked item on the corresponding shelf structure based on a planogram of the retail space that includes locations of the set of shelf structures in the retail space and a location of each stocked item on the set of shelf structures.

15. The device of claim 14, wherein the memory includes further instructions executable by the processing circuitry whereby the processing circuitry is configured to:
verify that the certain stocked item is at the location on the corresponding shelf structure based on image data received from at least one of the set of optical sensor devices that has the field of view towards the corresponding shelf structure.

16. The device of claim 11, wherein the memory includes further instructions executable by the processing circuitry whereby the processing circuitry is configured to:
determine navigation information from the current location of the wireless device or the subject in the retail space to a location of the certain stocked item on the corresponding shelf structure based on a retail space planogram and the current location of the subject or the wireless device.

17. The device of claim 11, wherein the memory includes further instructions executable by the processing circuitry whereby the processing circuitry is configured to:
send, by the network node device, to the wireless device over the network, an indication that includes navigation information from a current location of the wireless device or the subject in the retail space to a location of the certain stocked item on the corresponding shelf structure.

18. The device of claim 11, wherein the memory includes further instructions executable by the processing circuitry whereby the processing circuitry is configured to:
determine that the subject or the wireless device is approaching towards or is proximate a location of the certain stocked item on the corresponding shelf structure based on image data received from the optical sensor device or current location information received from the wireless device of the subject.

19. The device of claim 11, wherein the memory includes further instructions executable by the processing circuitry whereby the processing circuitry is configured to:
determine that the certain stocked item has been removed from the shelf structure while the subject or the wireless device is proximate the location of that certain stocked item; and
send, by the network node device, to the first display device over the network, an indication that includes a request to disable the auditory or visual indication.

20. A system, comprising:
a set of optical sensor devices positioned throughout a retail space having a set of shelf structures with each shelf structure having a portion of a set of stocked items with any of the same stocked items being transversely arranged on that shelf structure, each optical sensor device having an optical sensor with a field of view towards at least one of the set of shelf structures and operable to capture an image that includes the corresponding shelf structure;
a set of display devices with each display device being associated with and proximate a certain stocked item of the set of stocked items that is disposed on that shelf structure and operable to display a visual indication or generate an auditory indication; and
a network node device operationally coupled to the set of optical sensor devices and the set of display device over a network and operable to send, to a first display device of the set of display devices that is associated with and proximate a certain stocked item of the set of stocked items that is electronically requested, over the network, an indication that includes a request to enable an auditory or visual indication so that the certain stocked item can be located on a corresponding shelf structure of the set of shelf structures in the retail space based on the auditory or visual indication.
